(19) United States
(12) Patent Application Publication
(10) Pub. No.: US 2024/0202011 A1
(43) Pub. Date: Jun. 20, 2024

(54) METHOD FOR DYNAMICALLY CONNECTING A COMMUNICATION CHANNEL AND SOFTWARE SYSTEM USING THE SAME

(71) Applicant: CHUN-HSIAO LIN, New Taipei City (TW)

(72) Inventor: CHUN-HSIAO LIN, New Taipei City (TW)

(21) Appl. No.: 17/909,847

(22) PCT Filed: Mar. 9, 2021
(86) PCT No.: PCT/CN2021/079677

§ 371 Date: Sep. 7, 2022

Related U.S. Application Data
(63) Continuation of application No. 62/986,930, filed on Mar. 9, 2020.

(51) Int. Cl. G06F 9/445; H04L 9/40

(52) U.S. Cl. CPC G06F 9/44521; H04L 63/10

(57) ABSTRACT

The present invention relates to a method for dynamically connecting a network communication channel and a software system using the method. Especially, the present invention relates to a method for dynamically connecting a volatile network communication channel and a software system using the method.

### FIELD OF THE INVENTION

The present invention relates to a method for dynamically connecting a network communication channel, a machine for providing the network communication channel and a computer program product using the network communication channel, and more particularly to a method for dynamically connecting a network communication channel in a software system, a machine for providing the ability to connect the network communication channel, and a computer program product for conducting information exchange activities through the connection of the network communication channel.

### BACKGROUND OF THE INVENTION

Nowadays, the technologies of computer networks are continuously developed. For example, through telecommunication networks, internet or Internet, people have become accustomed to conducting various information exchange activities through the connection of network communication channels. The information exchange activities include message chats, voice calls, video calls, document collaborative editing activities, form online sign-off, or any instant interactive information exchange activities.

The demands on the network information exchange have stimulated the development of a large number of software services. For example, LINE, WhatsApp, WeChat, Facebook Messenger and Skype are widely used for message chats, voice calls and video calls in people's daily lives.

In order to connect to the network communication channel, a software service that can be used to connect the network communication channel has to be previously installed or imported into the respective software platforms, operating systems or machines of the users who want to connect the network communication channel. Moreover, after connecting to the network communication channel through the software service, the users can perform the required information exchange activities.

Generally, some software services are in the form of native applications, and these software services are installed or embedded in every newly shipped software platform, operating system or machine in a built-in manner. Consequently, the users can connect their corresponding network communication channels through the applications. In addition, some software services are also in the form of the native applications. The executable installation files of the native applications are registered and published to the online application store. The user can download the installation file from the online application store, and install the software service to the software platform, the operating system or the machine operated by the user through the installation file. Afterwards, some software services are provided to be operated by the user in the form of a Web system. Due to the dynamic loading characteristics of the Web system, each user can load the Web system to a browser or a WebView to connect the corresponding network communication channel through the URL address of the Web system. The browser is activated and executed in the operating system or machine operated by the user. The WebView can be activated and executed in a software platform operated by the user.

However, the conventional method for connecting the network communication channels has many limitations. For example, the native applications provide the software services in the built-in manner. Because of the commercial competition, it is difficult for the native applications to be built in all software platforms, operating systems or machines. Consequently, when the users need to connect a network communication channel, not all users can directly find the software service to connect the network communication channel in the software platforms, the operating systems or the machines operated by the users. The native applications that publish installation files through online application stores are limited by the users' preferences or storage spaces. That is, not all users are willing to install the native applications. If the download rate and the installation rate cannot be effectively increased and popularized, the network communication channels corresponding to the native applications cannot be connected through the software platforms, the operating systems or the machines operated by the users.

On the other hand, the software services developed in the form of the Web system also have many limitations. Although the software service developed by the Web system can send or share its URL address to allow the users to dynamically load the software service into a browser or a Web View for use, it is necessary for the users to be willing to open the URL address in order to enable the browser or the Web View to load the software service. However, for a long time, the users have had security concerns about the opening of URL links. Consequently, the software service connected to the network communication channel through the Web system is mainly used as a passive entrance of the network communication channel. After the user confirms the function and purpose of the URL address and clicks and opens the URL address, the software service can be loaded and used as the entrance of the network communication channel. Moreover, the hyperlink component used to represent the URL address can be displayed in a plain text or a multimedia. The plain text display of the hyperlink component is to directly display the URL address on the screen. The multimedia display of the hyperlink component is to capture the header of a webpage resource that is pointed by the URL address, combine the thumbnail, title and other information of the webpage resource and display the associated information on the screen in the form of the multimedia.

The passive entrance published through the URL address cannot allow the instant information exchange activities to be effectively connected. Take the instant voice call for example. When a user as a requester sends a voice call request from Taipei City to another user in Europe, the other user as a callee cannot know that the requester is preparing to send a voice call request to himself (herself). In the voice call request of the telecommunications network and the native application (e.g., Whatsapp, LINE, WeChat), the callee receives the familiar incoming call screen in the machine operated by himself (herself), and confirms the requester's intention to make a voice call request from the ringtone and the instant messages shown in the incoming call screen. In addition, after the callee operates the incoming call screen and answers the call, the callee connects the network communication channel for the instant voice call. The URL address of the Web system bring restrictions on the instant information exchange activities. Even if the URL address represents the intention of the voice call requester, the callee must confirm the function and the purpose of the URL address first, and then the callee opens the URL address to load the Web system in order to connect the network communication channel to make the instant voice call. However, after the user confirms the function and the purpose of the URL address, the voice call request is often ended. In other words, the procedure of waiting for the callee to confirm the URL address is an obstacle for the Web system to effectively perform instant information exchange activities.

In some Web systems that care about the users' experiences, when their back-end systems send out a request notification for the instant information exchange activity, the URL address of the Web system is placed into the request notification. In addition, the request notification contains some text messages to help the user confirm the intent of the URL address through the reading of text messages. Moreover, when the request notification is sent in the form of an e-mail, the back-end system will insert the URL address and the contained text message into a human-machine interface template which is designed in a HTML markup language. In addition, the request notification is presented in the e-mail in the form of a HTML page. The URL address can be hidden in a button control item for the user to click to open the URL address. Although the insertion of the HTML template can bring more polish to the request notification, the HTML template cannot be fully applied to all notification channels such as mobile short messages (SMS). Regardless of whether the intention statement of the request notification is modified through the text message entrainment or through the HTML page beautification, the content and the human-machine interface template are defined and embedded by the back-end system of the Web system, which is different from the user′ habit. Consequently, the wariness of the user on the security concerns will not be completely eliminated. Take the instant voice call of the mobile phone for example. The familiar incoming call screen of the user is provided by the mobile phone operating system or the communication software in the operating system.

Furthermore, regardless of the mobile short messages (SMS), the e-mails, the social network posts or the chat room messages or the group messages in the instant messaging software, the request notification of the instant information exchange activities transmitted by the URL addresses indeed have hidden safety dangers that are difficult to be cured in information security. For example, the mobile short messages, the e-mails, the social network posts, the chat room messages or the group messages in the instant messaging software or other third-party information transmission channels cannot effectively authorize and manage the URL address. The main reason is that it is technically impossible to use a URL address to identify what data, service, tool or activity on the network is connected to the URL address. Since the security specifications of the browser or the Web View run in each website through a sandbox, the third-party information transmission channel or its corresponding client software cannot spy on the execution contents of the website even if the URL address is opened. Consequently, it is usually only possible to isolate the URL addresses of the domains listed in the blacklist by setting up a blacklist, instead of providing a solution. Due to the lack of technical restrictions on authorization management capabilities, it is difficult to guard the URL addresses of the phishing websites, resulting in difficulty in accessing the instant information exchange activities.

With the development of the Web technology in recent years, the Web system can import a push mechanism of Web Push and establish a relatively instant interaction with users through the push notification provided by the browser. However, both of the App push function and the Web system push function are implemented when the user installs or executes the App or the Web system and agrees to the permission of enabling the push function. This means that the use of the push technology to publish the notifications of the instant information exchange activities still has technical bottlenecks that are difficult to be overcome. Firstly, if the user has never installed the App or accessed the Web system or even the user does not know the existence of the App and the Web system, the user is unable to know the authority of enabling the push function. Secondly, if the browser is closed or the computer used to install the App is shut down, it is unable to receive the notification of the instant information exchange activity. These technical bottlenecks not only affect the availability of the network communication service but also affect its reliability.

Moreover, between different browsers, Web Views, software platforms and operating systems, there are many technical limitations on the compatibility of the Web system support. Each browser, each WebView, each software platform and each operating system have different technical standards to support. Moreover, due to the security considerations, each Web system in the browser and the WebView runs in a sandbox. Consequently, the software services that are developed through the Web system and used to connect the network communication channels face very high technical challenges in compatibility. In this regard, a projectable workspace compatible with various browsers, WebViews, software platforms and operating systems can be developed. Moreover, a working environment is constructed through the projectable workspace, and the applications and the corresponding software service for connecting the network communication channels can be imported into the working environment. The applications compatible with the working environment can be directly imported into the working environment and formed as a unified tool. The applications incompatible with the working environment can be indirectly imported into the working environment through the integration of an adapter and formed as a unified tool. Consequently, after receiving a communication request containing a link address with a communication command, the projectable workspace can be first loaded into the browser, the WebView, the software platform or the operating system. Then, the projectable workspace completes the communication request according to the communication command and connects the network communication channel corresponding to the communication request.

Through the realization of the projectable workspace, the compatibility challenge is simplified. The compatibility of different browsers, WebViews, software platforms and operating systems only needs to be solved by the projectable workspace. Various applications for connecting the network communication channel can be compatible with the working environment of the projectable workspace through unification only, and these applications can run in various browsers, WebViews, software platforms or operating systems. However, if the projectable workspace lacks the tools that can execute the communication command, it is unable to provide services for the communication request and the communication commands contained in it. In addition, for launching the projectable workspace, the link address in the communication request still needs to be clicked by the user. In other words, this technology cannot effectively support the execution of the instant information exchange activities.

As mentioned above, in the technical field of the online instant information exchange, how to provide effective authorization management in response to the information exchange activities and the issued notification requests is an important technical topic. In addition, the compatibility of different browsers, WebViews, software platforms and operating systems is a research problem that needs to be overcome. More importantly, there is no method for dynamically connecting volatile network communication channels and no software system using this method. That is, there is no method and no software system for allowing the user to connect the network communication channel on the software platform, the operating system or the machine operated by the user without the need of previously installing or importing a software service that can be used to connect the network communication channel. Moreover, the effective method that can instantly access the required information exchange activities and the software system using this method still need to be developed.

### SUMMARY OF THE INVENTION

The present invention provides a method for dynamically connecting a volatile network communication channel and a software system using the method. Especially, the present invention provides a method for allowing the user to connect a network communication channel through the software platform, the operating system or the machine operated by the user without the need of allowing the user to previously install or import a software service that can be used to connect the network communication channel. Consequently, the instant information exchange activities can be accessed.

In accordance with an aspect of the present invention, a method for dynamically connecting a network communication channel in a software system is provided. Firstly, a software module is provided in the software system. The software module triggers the activation of a connection flow in response to an information exchange request. During the connection flow, a response interface corresponding to the information exchange request is generated for a user to operate according to a content of the information exchange request. Then, the user is guided to perform a task of accessing an information exchange activity through the response interface. The task of accessing the information exchange activity is executed by an external application that is dynamically loaded to run. The external application accesses the information exchange activity by connecting a network communication channel corresponding to the information exchange activity. The content of the information exchange request contains a link that is used to point to a network address of the external application. The external application is dynamically loaded to run through the network address during the connection flow.

In an embodiment, the information exchange request is issued when the information exchange activity is established, an invitation of the information exchange activity is received and/or an instant access event of the information exchange activity is triggered.

In an embodiment, the software system is a system firmware, an application, a software platform, a software engine, an operating system or any software system that can be extended by programs.

In an embodiment, the software module is provided in the software system in a form of a class library, a software component, a software agent, an application or any program code block that can run in the software system.

In an embodiment, the information exchange activity is a message chat, a voice call, a video call, a web conference, an online sign-off activity or any online activity that can be accessed through a network connection.

In an embodiment, the external application is a Web system, a native application or any software service that can be dynamically loaded to run, wherein when a startup module of the external application is dynamically loaded and executed, the external application is dynamically loaded to run.

In an embodiment, the link points to the network address of the external application, or the link is at least one code that is used to identify (locate) the network address pointing to the external application, wherein a content of the network address of the external application contains a location of the startup module of the external application.

In an embodiment, the external application provides compatible versions for different browsers, software platforms or operating systems, and the compatible versions are published on plural network addresses. When the external application is dynamically loaded to run, the network address determined by the link firstly points to a proxy server, and the network address is redirected to another network address of the plural network addresses by the proxy server, so that a compatible external application can be dynamically loaded to run via another network address. If the compatible external application can be directly and dynamically loaded to run, the network address does not need to be redirected.

In an embodiment, the startup module of the external application is dynamically loaded to run through a cache corresponding to the network address or another network address.

In an embodiment, the external application is dynamically loaded to run through an additional software module. The additional software module is another independently running software system or a software component that can dynamically load and run a heterogeneous system. A procedure of dynamically loading and running the external application through the additional software module is triggered by a program block that triggers the activation of the connection flow or an additional program block that executes the response interface. Before the external application is dynamically loaded to run, the startup module of the external module is not installed or imported into the additional software module and a machine running the additional software module. The external application and the software module are executed in the same OS process or different OS processes.

In an embodiment, the information exchange request is transmitted from an external network to a machine running the software system and the software module, and the information exchange request is transmitted to the software module through a data transmission and docking process of an internal system of the machine. The external network is a third-party information transmission channel corresponding to the information exchange activity. The software system is a third-party software system corresponding to the external application. When the information exchange request is sent, a transmission identification code for receiving the information exchange request is not registered to the third-party information transmission channel, the third-party software system and/or the software module through the machine by the external application. The transmission identification code is a token for a Push Notification/Push Service or any identification code for tracking a transmission relationship between the external application and the information exchange request.

In an embodiment, the process of identifying the information exchange request is implemented by identifying a data structure of the information exchange request (i.e., the information exchange request is generated according to the data structure), and/or the process of identifying the information exchange request is implemented by identifying the third-party information transmission channel (i.e., the third-party information transmission channel is an exclusive information transmission channel used to transmit the information exchange request), and/or the process of identifying the information exchange request is implemented by identifying a service identification code corresponding to the information exchange activity or the external application.

In an embodiment, the information exchange request is transmitted in an uncoded or encoded data payload. If the data payload is an encoded data payload, the encoded data payload is decoded during the data transmission and docking process, or the encoded data payload is decoded by the software system or the software module.

In an embodiment, the content of the information exchange request contains an information that is used to generate the response interface. The response interface is generated by the external application, the software system or the software module during an operation of the connection flow, or the response interface is generated by another software module that is triggered during the operation of the connection flow. A man-machine interface template of the response interface is applied when the response interface is generated. The task of accessing an information exchange activity is executed after a user performs an operation on an operable window component in the response interface. The operable window component has a confirmation intention to guide the user to access the information exchange activity.

In an embodiment, the response interface displays a visual operation interface, or the response interface displays the visual operation interface and provides a notification, wherein the notification is provided by generating a ringtone and/or entering a vibration mode.

In an embodiment, the network communication channel is a data transmission channel that is generated in a telecommunication network, internet, and/or Internet, wherein the data transmission channel is connected with a network server corresponding to the information exchange activity.

In an embodiment, the content of the information exchange request contains a metadata of the information exchange activity, and the metadata is sent to the external application in a form of parameters, wherein the external application connects the network communication channel to access the information exchange activity according to an information of the metadata.

In an embodiment, the metadata is embedded in the link in the content of the information exchange request.

In an embodiment, the software component that can dynamically load and run the heterogeneous system is a software component embedded in a software application, and the software component executes the heterogeneous system through a software engine that is independent of the software application, and/or the heterogeneous system is executed in an independent sandbox. The heterogeneous system is a software service that can be dynamically loaded to in the software engine or executed in the sandbox, wherein the heterogeneous system is a Web system, a native application or any software service that can be dynamically loaded to run. The sandbox is provided by the software application or the software component, wherein the software engine is a Web engine.

In an embodiment, the content of the information exchange request contains an access token for acquiring an authority of accessing the information exchange activity.

In an embodiment, the activation of the connection flow, the procedure of generating the response interface and the procedure of dynamically loading and running the external application are performed in the same OS process in the same machine, in different OS processes in the same machine and/or in different machines.

In an embodiment, the information exchange activity is an online activity that is generated through an interaction between at least one person and a network communication service. After accessing the online activity, the at least one person, or the at least one person and at least another person exchanges information in real time through the network.

In an embodiment, the network communication service is an authorized network communication service with permission. The permission is authorized by the third-party information transmission channel or the third-party software system so as to transmit the information exchange request. When the information exchange request is transmitted, the network communication service and a client software of the network communication service are not installed or imported into the third-party software system and a machine running the third-party software system.

In an embodiment, the external application is a client software of the network communication service.

In an embodiment, the information exchange request is used for importing a work process corresponding to the information exchange activity, and the work process is dynamically imported into a machine running the software module according to an execution state of the information exchange activity.

In accordance with another aspect of the present invention, a machine for dynamically connecting a volatile network communication channel is provided. Firstly, a software module is provided in the machine. The software module triggers the activation of a connection flow in response to an information exchange request. During the connection flow, a response interface corresponding to the information exchange request is generated for a user to operate according to a content of the information exchange request. Then, the user is guided to perform a task of accessing an information exchange activity through the response interface. The task of accessing the information exchange activity is executed by an external application that is dynamically loaded to run. The external application accesses the information exchange activity by connecting a network communication channel corresponding to the information exchange activity. The content of the information exchange request contains a link that is used to point to a network address of the external application. The external application is dynamically loaded to run through the network address during the connection flow.

In an embodiment, the information exchange request is issued when the information exchange activity is established, an invitation of the information exchange activity is received and/or an instant access event of the information exchange activity is triggered.

In an embodiment, the machine is a handheld computer, a desktop computer, a smart TV or any computer equipment with networking and computing capabilities.

In an embodiment, the software module is provided in the software system in a form of a firmware system, a software component, a software agent, an application, a software platform, a software engine, an operating system or any program code block that can run in the software system.

In an embodiment, the information exchange activity is a message chat, a voice call, a video call, a web conference, an online sign-off activity or any online activity that can be accessed through a network connection.

In an embodiment, the external application is a Web system, a native application or any software service that can be dynamically loaded to run, wherein when a startup module of the external application is dynamically loaded and executed, the external application is dynamically loaded to run.

In an embodiment, the link points to the network address of the external application, or the link is at least one code that is used to identify (locate) the network address pointing to the external application, wherein a content of the network address of the external application contains a location of the startup module of the external application.

In an embodiment, the external application provides compatible versions for different browsers, software platforms or operating systems, and the compatible versions are published on plural network addresses. When the external application is dynamically loaded to run, the network address determined by the link firstly points to a proxy server, and the network address is redirected to another network address of the plural network addresses by the proxy server, so that a compatible external application can be dynamically loaded to run via another network address. If the compatible external application can be directly and dynamically loaded to run, the network address does not need to be redirected.

In an embodiment, the startup module of the external application is dynamically loaded to run through a cache corresponding to the network address or another network address.

In an embodiment, the external application is dynamically loaded to run through an additional software module. The additional software module is another independently running software system or a software component that can dynamically load and run a heterogeneous system. A procedure of dynamically loading and running the external application through the additional software module is triggered by a program block that triggers the activation of the connection flow or an additional program block that executes the response interface. Before the external application is dynamically loaded to run, the startup module of the external module is not installed or imported into the additional software module and a machine running the additional software module. The external application and the software module are executed in the same OS process or different OS processes.

In an embodiment, the information exchange request is transmitted from an external network to a machine running the software system and the software module, and the information exchange request is transmitted to the software module through a data transmission and docking process of an internal system of the machine. The external network is a third-party information transmission channel corresponding to the information exchange activity. The software system is a third-party software system corresponding to the external application. When the information exchange request is sent, a transmission identification code for receiving the information exchange request is not registered to the third-party information transmission channel, the third-party software system and/or the software module through the machine by the external application. The transmission identification code is a token for a Push Notification/Push Service or any identification code for tracking a transmission relationship between the external application and the information exchange request.

In an embodiment, the process of identifying the information exchange request is implemented by identifying a data structure of the information exchange request (i.e., the information exchange request is generated according to the data structure), and/or the process of identifying the information exchange request is implemented by identifying the third-party information transmission channel (i.e., the third-party information transmission channel is an exclusive information transmission channel used to transmit the information exchange request), and/or the process of identifying the information exchange request is implemented by identifying a service identification code corresponding to the information exchange activity or the external application.

In an embodiment, the information exchange request is transmitted in an uncoded or encoded data payload. If the data payload is an encoded data payload, the encoded data payload is decoded during the data transmission and docking process, or the encoded data payload is decoded by the software system or the software module.

In an embodiment, the content of the information exchange request contains an information that is used to generate the response interface. The response interface is generated by the external application, the software system or the software module during an operation of the connection flow, or the response interface is generated by another software module that is triggered during the operation of the connection flow. A man-machine interface template of the response interface is applied when the response interface is generated. The task of accessing an information exchange activity is executed after a user performs an operation on an operable window component in the response interface. The operable window component has a confirmation intention to guide the user to access the information exchange activity.

In an embodiment, the response interface displays a visual operation interface, or the response interface displays the visual operation interface and provides a notification, wherein the notification is provided by generating a ringtone and/or entering a vibration mode.

In an embodiment, the network communication channel is a data transmission channel that is generated in a telecommunication network, internet, and/or Internet, wherein the data transmission channel is connected with a network server corresponding to the information exchange activity.

In an embodiment, the content of the information exchange request contains a metadata of the information exchange activity, and the metadata is sent to the external application in a form of parameters, wherein the external application connects the network communication channel to access the information exchange activity according to an information of the metadata.

In an embodiment, the metadata is embedded in the link in the content of the information exchange request.

In an embodiment, the software component that can dynamically load and run the heterogeneous system is a software component embedded in a software application, and the software component executes the heterogeneous system through a software engine that is independent of the software application, and/or the heterogeneous system is executed in an independent sandbox. The heterogeneous system is a software service that can be dynamically loaded to in the software engine or executed in the sandbox, wherein the heterogeneous system is a Web system, a native application or any software service that can be dynamically loaded to run. The sandbox is provided by the software application or the software component, wherein the software engine is a Web engine.

In an embodiment, the content of the information exchange request contains an access token for acquiring an authority of accessing the information exchange activity.

In an embodiment, the activation of the connection flow, the procedure of generating the response interface and the procedure of dynamically loading and running the external application are performed in the same OS process in the same machine, in different OS processes in the same machine and/or in different machines.

In an embodiment, the information exchange activity is an online activity that is generated through an interaction between at least one person and a network communication service. After accessing the online activity, the at least one person, or the at least one person and at least another person exchanges information in real time through the network.

In an embodiment, the network communication service is an authorized network communication service with permission. The permission is authorized by the third-party information transmission channel or the third-party software system so as to transmit the information exchange request. When the information exchange request is transmitted, the network communication service and a client software of the network communication service are not installed or imported into the third-party software system and a machine running the third-party software system.

In an embodiment, the external application is a client software of the network communication service.

In an embodiment, the information exchange request is used for importing a work process corresponding to the information exchange activity, and the work process is dynamically imported into a machine running the software module according to an execution state of the information exchange activity.

In accordance with another aspect of the present invention, a computer program product is provided. The computer program product is a software system. By using a method for dynamically connecting a volatile network communication channel, a system user operating the software system is permitted to conduct an information exchange activity with an external user. The software system includes a software module. The software module is included in the software system. The software module receives an information exchange request that is issued from the external user and contains a link, and the software module triggers an activation of a connection flow. During the connection flow, a response interface corresponding to the information exchange request is generated according to a content of the information exchange request, and an external application is dynamically loaded for allowing the system user to operate the response interface and guiding the system user to access the information exchange activity. The link is used to point to a network address of the external application. The external application is dynamically loaded to run through the network address during the connection flow. The external application accesses the information exchange activity by connecting a network communication channel corresponding to the information exchange activity.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrating the operating concepts of dynamically loading and running a software service according to an embodiment of the present invention;

FIG. 2 is a flowchart illustrating a method for dynamically connecting a volatile network communication channel according to an embodiment of the present invention;

FIG. 3 is a schematic functional block diagram illustrating the network configuration of a network voice call service according to an embodiment of the present invention;

FIG. 4A schematically illustrates the operating concepts of the method for dynamically connecting the volatile network communication channel according to an embodiment of the present invention;

FIG. 4B schematically illustrates an operating concept of installing or importing the external application into the mobile phone as shown in the embodiment of FIG. 4A;

FIG. 4C schematically illustrates an incoming call request data payload as an example of the short message content of the incoming call request as shown in FIG. 4A;

FIG. 4D schematically illustrates the operating concepts of the method for dynamically connecting the volatile network communication channel according to another embodiment of the present invention;

FIG. 4E schematically illustrates the operating concepts of the method for dynamically connecting the volatile network communication channel according to another embodiment of the present invention;

FIG. 4F schematically illustrates the operating concepts of the method for dynamically connecting the volatile network communication channel according to another embodiment of the present invention;

FIG. 5 schematically illustrates the operating concepts of the method for dynamically loading different compatible versions of external applications that can be used in all embodiments of the present invention;

FIG. 6 schematically illustrates the operating concepts of various operating paths of the connection flows in FIGS. 4D to 4F;

FIG. 7A schematically illustrates a concept of implementing the information exchange activity with a Hypermedia as the Engine of Application State (HATEOAS) according to an embodiment of the present invention;

FIG. 7B schematically illustrates an example of detecting the call state of the network voice call corresponding to FIG. 7A;

FIG. 7C schematically illustrates an example of the response of the network communication service as shown in FIG. 7B to the call state detection; and

FIG. 7D schematically illustrates an example of a call record for allowing the user to call back the network voice call as shown in FIG. 7C.

### DETAILED DESCRIPTION OF THE PREFERRED EMBODIMENT

The present invention is more fully appreciated by reference to the following description, including the following glossary of terms and the concluding examples. For the sake of brevity, the disclosures of the publications, including patents, cited in this specification are herein incorporated by reference.

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The following embodiments of the present invention are non-limiting embodiments, and only represent various aspects and features of the present invention. In the most restrictive technical sense, the term “external application” used herein includes a Web system, a native application or any software service that can be dynamically loaded to run. The term “software module” used herein includes a class library, a software component, a software agent, an application or any program code block that can be built, installed, imported or expanded into the “software system”. The term “software system” used herein includes a system firmware, an application, a software platform, a software engine, an operating system or any software system that can be extended by programs. The term “information exchange activity” used herein includes a message chat, a voice call, a video call, a web conference, an online sign-off activity or any online activity that can be accessed through the network connection. The term “response interface” used herein is a man-machine operation interface. The designed purpose of the man-machine operation interface is to respond to an information exchange request for an information exchange activity. The man-machine interface template of the man-machine operation interface is designed for the application purpose of the information exchange request. The man-machine operation interface may include the invitation notification of the message chat room, the incoming call screen of the voice call, the incoming call screen of the video call, the incoming call screen of the network conference, the request screen of the online sign-off activity, or any kind of human-machine interface for guiding the user to respond to the information exchange request. It is noted that the examples of the external applications, the software modules, the software systems, the information exchange activities and the response interfaces are not restricted.

In this context, the term “external application” indicates a software service that can be dynamically loaded to run through a network address. The external application is deployed, stored or published in an external server. The external server can be a Web server, a cloud storage server, an online application store server, or any other computing device that is used to deploy, store or publish a software service. The external server and the machine where the “software system” and the “software module” are located are different computing devices. Before the external application is dynamically loaded, the startup module of the external application has not been installed or imported into the machine running the “software system” and “software module” described herein. When the service provided by the external application needs to be executed, the service provided by the external application can only be operated after the external application is dynamically loaded from the external server through the network address.

The term “information exchange activity” used herein is an online activity that allows users to exchange information through the network. The online activity may be an online activity that is generated through the interaction between at least one person and a software service, and the online activity is used to allow the at least one person (or the at least one person and at least another person accessing the online activity) to exchange information in real time through the network. The software service is provided by an application, an information system, a connected device, a network server, and a combination thereof. It is noted that the example of the online activity is not restricted. In this context, the “information exchange request” is a request that is issued when the information exchange activity is established, an invitation of the information exchange activity is received and/or an instant access event of the information exchange activity is triggered.

The term “human-machine interface template” used herein indicates a layout design of the human-machine interface. For a Web system, the man-machine interface template is designed with a presentational markup language (e.g., Presentational Markup) supplemented by a procedural markup language (e.g., Procedural markup). HTML is the main markup language technology used by the Web system. For the native application, the man-machine interface template can be designed in a markup language (e.g., Markup Language), and it can be designed by directly providing the man-machine interface related information in the program code without relying on the markup language. The definitions of the markup languages can be referred to the following webpage at https://en.wikipedia.org/wiki/Markup_language.

In this context, the term “third-party information transmission channel” used herein includes a mobile short message transmission channel, an e-mail transmission channel, or any message transmission channel that can be used to transmit the information exchange request. In an embodiment, the information transmission channel is a public information transmission channel. For example, both of the mobile short message transmission channel and the e-mail transmission channel belong to the public information transmission channel. As long as a mobile phone number or an e-mail address is grasped, the information exchange request can be sent out through the service of mobile short message or e-mail. Alternatively, the information transmission channel is a private information transmission channel. For example, the private information transmission channel is a Push Notification service provided by the enterprise and/or built in the receiver device, or the private information transmission channel is an information transmission channel that is constructed through a network through an application (App) provided by the enterprise and installed in the receiver device. If the user of the application provides any kind of code (e.g., a mobile phone number or email address) that can be used for identification purposes during the registration process of the application, the corresponding user account can be queried according to the code for the identification purpose. Moreover, the information exchange request can be sent to the corresponding user through the information transmission channel constructed through the application. The term “OS process” used herein indicates the process that is used for loading, driving, starting and/or executing programs by the operating system. The definitions of the OS process can be referred to the following webpage at “https://en.wikipedia.org/wiki/Process_(computing)”.

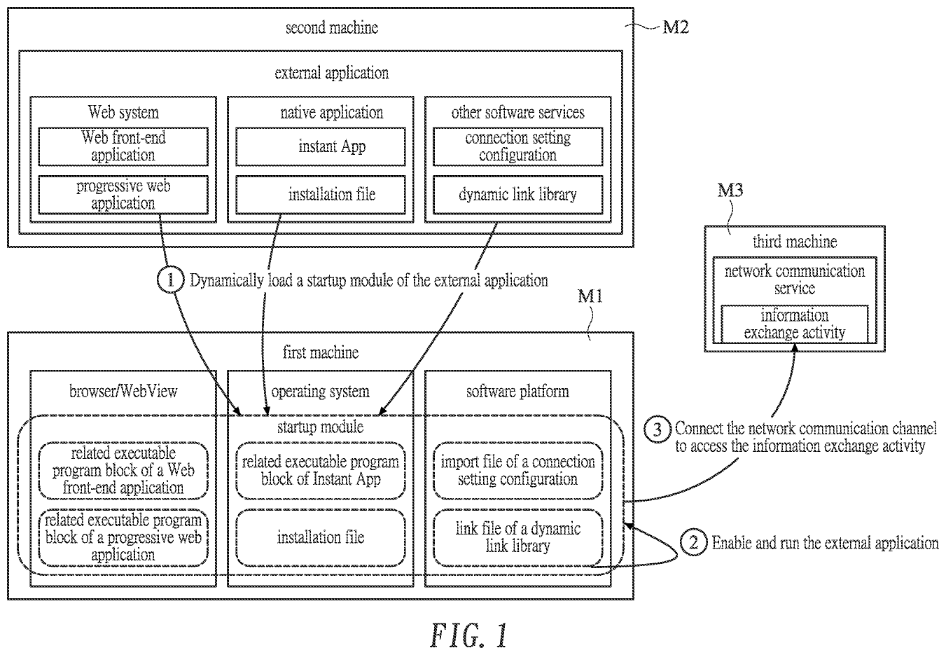

Hereinafter, some embodiments of the present invention will be provided to illustrate the concepts of the present invention. FIG. 1 schematically illustrating the operating concepts of dynamically loading and running a software service according to an embodiment of the present invention. In accordance with a flowchart of dynamically loading and running an external application, a machine M1 (first machine M1) loads a startup module of the external application from another machine M2 (second machine M2), and the service provided by the external application is enabled on the machine M1. The startup module includes a related executable program block of a Web front-end application, a related executable program block of a progressive web application, a related executable program block of Instant App, an installation file of a native application, a link file of a dynamic link library and an import file of a connection setting configuration, or the startup module is a software module that can be used to activate the external application. The external application that is dynamically loaded and started to run on the machine M1 can use TCP/IP Socket, UDP Socket and/or WebSocket technology to establish the connection with the external machine M3 (the third machine M3) through a 4G/5G telecommunication network, an Ethernet network, a WiFi wireless network and/or the Internet based on these networks. With the assistance of SIP (Session Initiation Protocol), WebRTC or other standardized and/or customized communication protocols, a network communication channel can be connected from the machine M1 to the network communication service in the external machine M3 in order to access the information exchange activity. The connection between the machine M1 and the external machine M3 through the network communication channel is implemented by establishing at least one network connection line through at least one network infrastructure and through the interaction of at least one communication protocol. It is noted that the method of connecting the network communication channel is not restricted. According to the application scenarios of different information exchange activities, “the network infrastructure of the physical layer and the data link layer”, “the network connection between the network layer and the transport layer” and “the communication protocol between the application layer, the presentation layer and the session layer” can have different options. The definitions of the physical layer, the data link layer, the network layer, the transport layer, session layer, the presentation layer and the application layer can be referred to the webpage of a seven-layer OSI model at https://en.wikipedia.org/wiki/OSI_model. The Internet is a network infrastructure built above the seven layers of the OSI network and connected according to the HTTP protocol. The WebSocket is an implementation example of establishing connection in Internet. That is, the network communication channel is a data transmission channel that is generated in a telecommunication network, internet, and/or Internet. Moreover, the data transmission channel is connected with a network server corresponding to the information exchange activity. The technology related to network programming design is very popular, and those skilled in the art can make any equal design changes based on actual application requirements. Some methods of dynamically loading an external application to run will be described as follows.

The first method is a method of dynamically loading a Web system. Take the Web front-end application and the progressive web application (e.g., Progressive Web App) for example. The Web front-end application and the progressive web application are developed according to HTML/CSS/Javascript technologies. The Web front-end application can be published as a progressive web application (e.g., Progressive Web App). The implementation methods can be referred to the following webpage at “https://vaadin.com/learn/tutorials/learn-pwa/turn-website-into-a-pwa”. Firstly, a Web front-end application is deployed on a web server. In addition, the Web front-end application is published in the form of a progressive web application. For example, the URL address of the Web front-end application is “https://a.b.c/app”. Moreover, the same URL is used as the start_url of the progressive web application. Then, in any computing device that supports WebView or installs a browser, the URL address “https://a.b.c/app” is able to be opened through a WebView or a browser. Consequently, the Web front-end application is dynamically loaded to run in the Web View or the browser. Each of the browser and the WebView has an HTML/CSS/Javascript software engine. In the same operating system, the HTML/CSS/Javascript software engine can be shared. Both of the browser and the Web View are the software systems that can dynamically load and run a Web front-end application. The difference between the two software systems is mainly related to the importing way. The browser is installed in the operating system in the form of an independent application. The WebView is a component-based software system and embedded in the man-machine interface of a native application for providing the native application with the ability to dynamically load and run the Web front-end application. For the native application, the Web View is a software component that can dynamically load and run a heterogeneous system. The heterogeneous system is a Web front-end application.

In an embodiment, a Windows application developed in Java is provided. During the execution of the Windows application, if a URL address https://a.b.c/app?incoming_call_id=“AB46F”&user_id=“U12345” is received, and a browser is launched by calling java.awt.Desktop.browse (“https://a.b.c/app?incoming_call_id=\“AB46F\”&user_id=“U12345””). Consequently, the Web front-end application is dynamically loaded to run in the browser.

In another embodiment, an Android native application is provided. An Android Activity of the Android native application is embedded into a Web View software system. During the execution of the Android native application, if the URL address “https://a.b.c/app?incoming_call_id=”AB46F″&user_id=“U12345” is received, request the Web View to open the URL address. Consequently, the Web front-end application is dynamically loaded to run in the Web View.

In another embodiment, the Web front-end application is published in the form of a progressive web application. Consequently, the Web front-end application can be imported into a launcher of an Android phone through a Chrome browser. When the Web front-end application is imported into the launcher of the Android phone, the Web front-end application is modeled as a WebAPK and then imported. While the Web front-end application is imported successfully, the related executable program block of the Web front-end application is not imported into the phone. When the WebAPK in the launcher of the Android phone is opened, the related executable program block of the Web front-end application is dynamically loaded and executed, and drive the Web front-end application to be dynamically loaded to run. Then, a Java program can be provided to the Android phone. During the execution of the Java program, if the URL address “https://a.b.c/app?incoming_call_id=”AB46F″&user_id=“U12345“ ” is received, an Android Intent request is issued to open the URL address. The Android Intent request will then be received by the WebAPK, and the task of dynamically loading and running the Web front-end application is performed by the WebAPK. A method of opening the URL address through the Android Intent request can be referred to the following example of the program codes:

```
  val openURL = Intent(android.content.Intent.ACTION_VIEW);
  openURL.data = Uri.parse(“https://a.b.c/app?incoming_call_id=\“AB46F\”&
user_id=“U12345””);
  startActivity(openURL);
```

In the above embodiments of dynamically loading the Web front-end application, when the Web front-end application is dynamically loaded to run in the browser, the Web View or the OS process of the WebAPK, the incoming URL network address https://a.b.c/app? incoming_call_id=“AB46F”&user_id=“U12345” can be analyzed, and the information contained in the URL address can be obtained. That is, the information contained in the URL address is the URL Query Parameter “incoming_call_id=”AB46F″ and user_id=“U12345”. In this way, the metadata of an information exchange activity in the parameter form of URL Query Parameter can be transmitted to the Web front-end application and/or the corresponding back-end program that is dynamically loaded to run. The Web front-end application and/or the corresponding back-end program can connect a network communication channel to the network communication service corresponding to the information exchange activity and access the information exchange activity according to the information provided by the metadata (e.g., the call ID and user ID of the information exchange activity and the IP or Domain information of the network communication service corresponding to the information exchange activity).

In an embodiment, the information exchange activity may be a REST Resource, and the Resource State of the information exchange activity is stored in the back-end system corresponding to the Web front-end application. The REST Resource State includes the metadata of the information exchange activity (e.g., the call ID and user ID of the information exchange activity, and the IP or Domain information of the network communication service corresponding to the information exchange activity). In this situation, the information exchange activity can be combined with the web address of the Web front-end application and provided in the form of a URL representing a resource, e.g., “https://abc/call/AB46F/user/U12345/incoming.activity”. When the URL representing a resource is opened in a browser, the Web front-end application used to process incoming.activity will be dynamically loaded to run in it. In the back-end system, the metadata of the information exchange activity can be directly obtained from the REST Resource State of the information exchange activity. Consequently, in this way, the metadata of the information exchange activity does not need to be transmitted to the dynamically loaded Web front-end application and/or the corresponding back-end program in the parameter form of URL Query Parameter. The technical contents of the progressive web application (e.g., Progressive Web App) be to can referred the webpage at https://en.wikipedia.org/wiki/Progressive_web_application. The technical contents of the WebRTC communication technology can be referred to the webpage at https://webrtc.org/. Moreover, the technical contents of the Web View can be referred to the webpage at https://developer.android.com/reference/android/webkit/Web View. The technical contents of the Android Activity can be referred to the webpage at https://developer.android.com/reference/android/app/Activity. The technical contents of the WebAPK can be referred to the webpage at https://developers.google.com/web/fundamentals/integration/webapks. The technical contents of the URL Query Parameter (URL Query String) can be referred to the webpage at https://en.wikipedia.org/wiki/Query_string. The technical contents of the REST Resource can be referred to the webpage at https://restfulapi.net/statelessness/.

The second method is a method of dynamically loading a native application. Take the Android Instant App for example. The Android Instant App is a technology promoted by Google. The associated technical contents can be referred the webpage at to https://developer.android.com/topic/instant-apps/index.html. This technology is designed to simulate the dynamic loading and running capabilities of the Web system for Android native applications. The application developers can perform a modular process on the Android native application. When the Android native application is launched on the online application store, the corresponding URL address for a module can be set as the dynamic loading location of the module. After the module is launched and released, the module is the said Android Instant App.

In an embodiment, an Android native application is executed on the mobile phone. During the execution of the Android native application, if the URL address of an Android Instant App is received, a command line instruction is executed by calling java.lang.Runtime.getRunTime( ).exec (i.e., a common line instruction). According to the command line instruction, the adb tool is driven, and the URL is activated through the adb tool. Consequently, the Android Instant App corresponding to the URL address can be dynamically loaded to run. The method of driving the adb tool to activate the command line instruction may be referred to the literature: adb shell am start -a android.intent.action. VIEW\-d “The URL address of the Android Instant App”.

In an embodiment, after the Android Instant App is dynamically loaded to run and during the execution of the Android Instant App, the URL Query Parameter embedded in the URL address can be obtained by calling android.app.Activity.getIntent( ).getData( ).getQueryParameter( . . . ). As a consequence, a metadata of an information exchange activity can be transmitted to the dynamically loaded Android Instant App in the parameter form of URL Query Parameter. The Android Instant App can connect a network communication channel to the network communication service corresponding to the information exchange activity and access the information exchange activity according to the information provided by the metadata (e.g., the call ID and user ID of the information exchange activity and the IP or Domain information of the network communication service corresponding to the information exchange activity).

The third method is a method of dynamically loading a native application. Take an executable installation file of the native application for example. The executable installation file of the Android native application is packaged in the form of an .apk file. As a native application, the .apk file can be stored in an FTP network server. In addition, “ftp://a.b.c/app.apk” is served as the download address of the .apk file (app.apk).

Moreover, in the Android OS with the permission of “allowing to install .apk files in the system background”, a program block is provided. During the execution of the program block, if a URI address ftp://a.b.c/app.apk?incoming_call_id=“AB46F”&user_id=“U12345”&pack age=“voip.app”&activity=“voip.app.CallActivity” is received, a dynamic loading process is firstly performed. The program block generates an FTP connection and connects to the FTP network server “ftp://a.b.c” according to the server Domain Name information (i.e., “ftp://a.b.c”) contained in the URI address. After the FTP connection is established, a request is issued to download the .apk file (app.apk) from the FTP network server. After the download process is completed, the program block will execute a command line instruction to request the adb tool to execute “adb install the storage path of the .apk file” and install the .apk file (app.apk) through the command line instruction. After the installation is completed, another command line instruction is performed to request the adb tool to execute “adb shell am start -a android.intent.action. VIEW-c android.intent.category.DEFAULT-es incoming_call_id AB46F-es user_id U12345-n voip.app/voip.app.CallActivity”, and the another command line instruction is performed to active the Android native application (voip.app.CallActivity) that is packaged in the .apk file (app.apk). Consequently, the task of dynamically loading and running the .apk file (app.apk) can be completed. Therein, the parameters in the another command line instruction including AB46F (incoming_call_id), U12345 (user_id), voip.app (package) and voip.app.CallActivity (activity) can be obtained after the URI address is parsed by the program block.

In an embodiment, the relevant metadata of an information exchange activity can be transmitted to the dynamically loaded Android native application in the same method. The Android native application can connect a network communication channel to the network communication service corresponding to the information exchange activity and access the information exchange activity according to the information provided by the metadata (e.g., the call ID and user ID of the information exchange activity and the IP or Domain information of the network communication service corresponding to the information exchange activity).

The fourth method is a method of dynamically loading a software service. Take the dynamic link library for example. In the Java technology ecosystem, the dynamic link library is released in the form of a .jar file. As a dynamic link library, the .jar file can be stored in an FTP network server. In addition, “ftp://a.b.c/lib.jar” is served as the download address of the .jar file (lib.jar).

In an embodiment, a software server and a Windows application developed with Java technology are provided. The Windows application is a software platform that can extend the application functions through plug-in dynamic link program library. In addition, the Windows application provides a Java RMI interface. Consequently, when the software server receives a URI address, the software server can drive the Windows application to dynamically load and run an external dynamic link program library by calling the functions provided by the Java RMI interface. During the execution of the software server, if a URI address ftp://a.b.c/lib.jar?incoming_call_id=“AB46F”&user_id=“U12345” is received and the URI address is judged to point to a dynamic link program library that can be dynamically loaded to run by the Windows application, the software server will transmit the URI address to the Windows application through the Java RMI interface and thus drive the Windows application to execute the dynamic loading process. After the Windows application receives the request to dynamically loading and running a dynamic link program library, the Windows application generates an FTP connection and connects to the FTP network server “ftp://a.b.c”. After the FTP connection is established, a request is issued to download the .jar file (lib.jar), the dynamic link program library, from the FTP network server. After the download process is completed, the .jar file (lib.jar) is placed in a directory. Then, the dynamic link program library is loaded from the directory through a software library interface that the Windows application and the dynamic link program library both conform to. Moreover, through this software library interface, the software object instantiated from the dynamic link program library is driven to provide a software service. As a consequence, in the OS process of the Windows application, the dynamic link program library can be dynamically loaded to run. The software library interface is used as a standard protocol for the software function calls between the Windows application and the dynamic link program library. For the dynamic link program library, each system platform technology ecology has its corresponding dynamic link library implementation such as the .dll file of Windows and .so file of Linux. The technical contents of Java RMI can be referred to a webpage at https://en.wikipedia.org/wiki/Java_remote_method_invocation.

In an embodiment, a metadata related to the information exchange activity is embedded in the URI address in the parameter form of URL Query Parameter. The Windows application can obtain the relevant metadata by analyzing the URI address. Moreover, the Windows application can define a function for passing the metadata in the software library interface. Consequently, the dynamic link program library must provide the corresponding implementation of the function. In this way, through the function, the Windows application can transmit the metadata in the form of function parameters to the software object, which provides the software service, instantiated from the dynamic link program library. The object can connect a network communication channel to the network communication service corresponding to the information exchange activity and access the information exchange activity according to the information provided by the metadata (e.g., the call ID and user ID of the information exchange activity and the IP or Domain information of the network communication service corresponding to the information exchange activity).

The fifth method is a method of dynamically loading a software service. Take the connection setting configuration for example. In the Microsoft Windows technology ecosystem, RemoteApp is an extended application of remote desktop connection. The characteristic of the RemoteApp is that the control of the remote desktop connection can transmit the display information of the remote application during the runtime to the client and then the client generates the screen according to the displayed information. The process of publishing the RemoteApp is completed with a .rdp connection profile. The contents of the connection profile contain the connection location and the login information of the remote desktop server and the application settings to be launched. On the client machine, a .rdp connection profile is launched through the mstsc remote desktop software platform. The mstsc remote desktop software platform may perform the connection process according to the configuration information of the .rdp connection profile. After the connection process is completed, the remote application pointed by the .rdp connection profile will appear as if the remote application runs on the local machine.

In an embodiment, a remote conference APP for answering network calls can be installed in the server side. In addition, a .rdp file (app.rdp) corresponding to the remote conference APP is stored in an FTP network server. In addition, “ftp://a.b.c/app.rdp” is served as the download address of the .rdp file (app.rdp).

In an embodiment, a Windows application is provided. During the execution of the Windows application, if a URI address ftp://a.b.c/app.rdp?incoming_call_id=“AB46F”&user_id=“U12345” is received, a dynamic loading process is enabled. Consequently, an FTP connection is generated and connected to an FTP network server “ftp://a.b.c”. After the FTP connection is established, a request is issued to download the .rdp file (app.rdp) from the FTP network server. After the download process is completed, the command line instruction-driven method through the API provided by Windows is used, and thus the mstsc remote desktop software platform can be driven to launch the .rdp file (app.rdp). Consequently, the task of loading the remote conference APP to run is completed. For example, Citrix XenApp and Winflector are both implementation examples of the remote applications extended by the remote desktop connection.

In an embodiment, a metadata related to the information exchange activity is embedded in the URI address in the parameter form of URL Query Parameter (e.g., incoming_call_id=“AB46F” and &user_id=“U12345”). The Windows application can obtain the relevant metadata by analyzing the URI address. In addition, when the command line instruction-driven method is used to drive the mstsc remote desktop software platform to dynamically load and run the .rdp file (app.rdp), the relevant metadata is sent to the remote conference APP by adding /REMOTECMDLINE. For example, when “mstsc /REMOTECMDLINE: incoming_call_id=AB46F,user_id=U12345 path\to\lapp.rdp” is executed in the command line, the remote conference APP is enabled to receive the parameters incoming_call_id=AB46F,user_id=U12345. In this way, the remote conference APP corresponding to the .rdp file (app.rdp) can connect a network communication channel to the network communication service corresponding to the information exchange activity and access the information exchange activity according to the information provided by the metadata.

In an embodiment, the metadata related to the information exchange activity is previously written into the .rdp file (app.rdp). Consequently, when the .rdp file (app.rdp) is downloaded, it is not necessary to transmit the related metadata in the parameter form of /REMOTECMDLINE to the mstsc. When the .rdp file (app.rdp) and the corresponding remote call APP are dynamically loaded to run, the remote call APP can connect a network communication channel to the network communication service corresponding to the information exchange activity and access the information exchange activity according to the related metadata that has been previously written into the .rdp file (app.rdp).

It is noted that the above methods of dynamically loading and running an external application and accessing the information exchange activities are only non-limiting examples. The method of dynamically loading and running the external application from the external server and accessing the information exchange activity is not restricted. That is, those skilled in the art can make any equal design changes based on actual application requirements.

From the above descriptions, the present invention provides a method for dynamically connecting a volatile network communication channel. Especially, the present invention provides a method for allowing the user to connect a network communication channel through the software platform, operating system or machine operated by the user without the need of allowing the user to previously install or import a software service that can be used to connect the network communication channel. Consequently, the instant information exchange activities can be accessed.

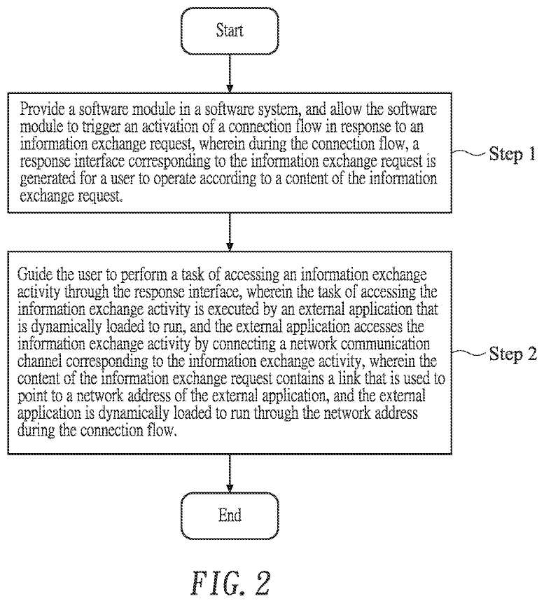

FIG. 2 is a flowchart illustrating a method for dynamically connecting a volatile network communication channel according to an embodiment of the present invention. The method for dynamically connecting a volatile network communication channel comprises the following steps:
Step 1: providing a software module in a software system, and allowing the software module to trigger an activation of a connection flow in response to an information exchange request, wherein during the connection flow, a response interface corresponding to the information exchange request is generated for a user to operate according to a content of the information exchange request; and
Step 2: guiding the user to perform a task of accessing an information exchange activity through the response interface, wherein the task of accessing the information exchange activity is executed by an external application that is dynamically loaded to run, and the external application accesses the information exchange activity by connecting a network communication channel corresponding to the information exchange activity, wherein the content of the information exchange request contains a link that is used to point to a network address of the external application, and the external application is dynamically loaded to run through the network address during the connection flow.

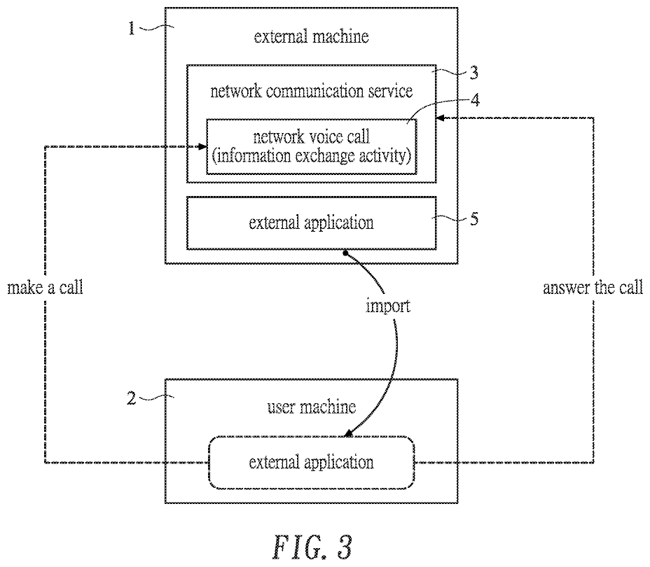

FIG. 3 is a schematic functional block diagram illustrating the network configuration of a network voice call service according to an embodiment of the present invention. The network voice call 4 is an information exchange activity. The external machine 1 is a network connected server. In the external machine 1, a Web system is deployed in a Web server, and network communication service 3 and an external application 5 are deployed in the Web system. The network communication service 3 is a back-end system used to generate and manage the network voice call 4 (i.e., the information exchange activity), and thus provide the functions of making and answering calls. The external application 5 is published in the Internet as a progressive web application (e.g., Progressive Web App). Consequently, the user may import the external application 5 into the user machine 2 through a browser or an online application store; or a browser or a WebView on the user machine 2 may be used to open the network address of the external application 5 on the Internet, so that the external application 5 is dynamically loaded to run in the browser or the WebView. After the external application 5 is dynamically loaded to run in the user machine 2, the external application 5 can interact with network communication service 3 through the HTTP protocol and the WebRTC communication technology. Moreover, through the HTTP protocol and the WebRTC communication technology, the external application 5 that is dynamically loaded to run in the user machine 2 can connect a network communication channel to the network communication service 3 and make and answer the network voice call 4 through the network communication service 3. Generally, the action of answering one network voice call 4 is an example of accessing one information exchange activity. After the progressive web application (e.g., Progressive Web App) is imported into the user machine 2 through the online application store, the progressive web application is able to be directly activated on the desktop management of the user machine 2. The domain name of the external machine 1 is “a.b.c”, and the network address of the external application 5 is “https://a.b.c/app”. In other words, the external application 5 can be regarded as a client software of the network communication service 3.

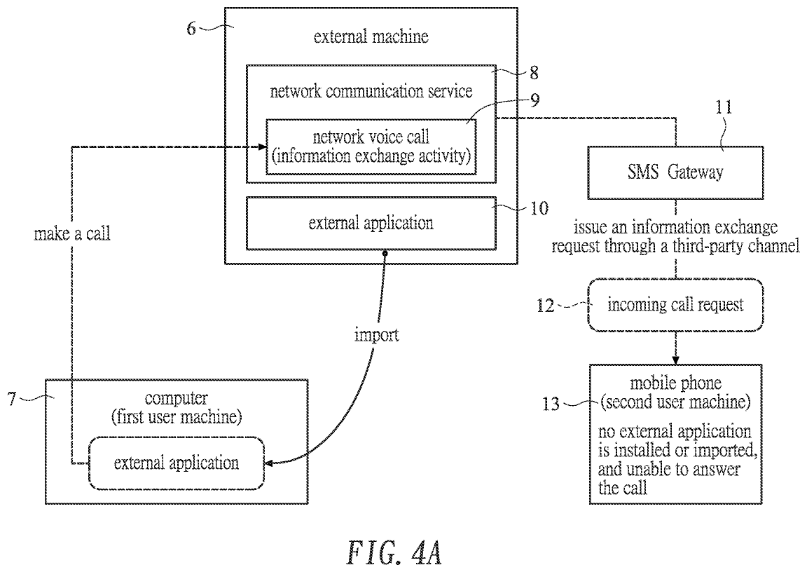

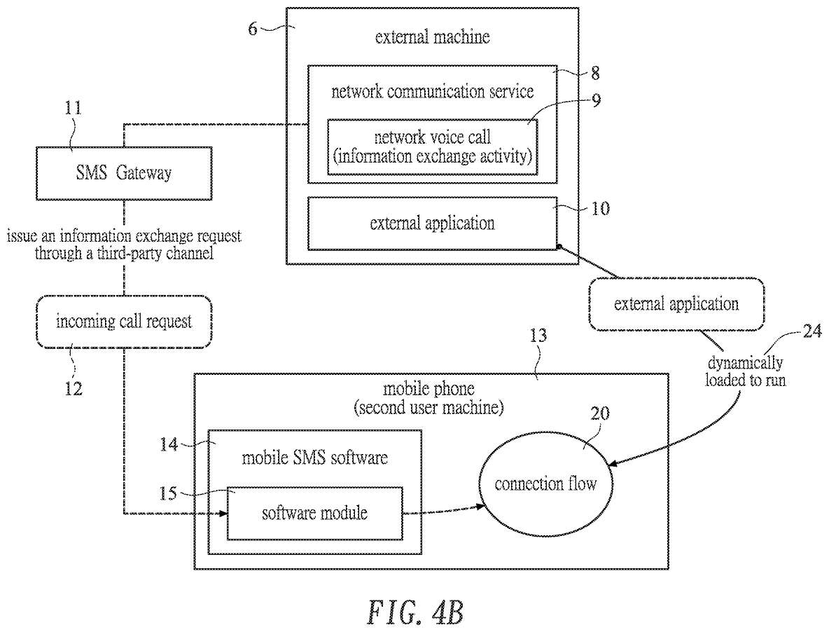

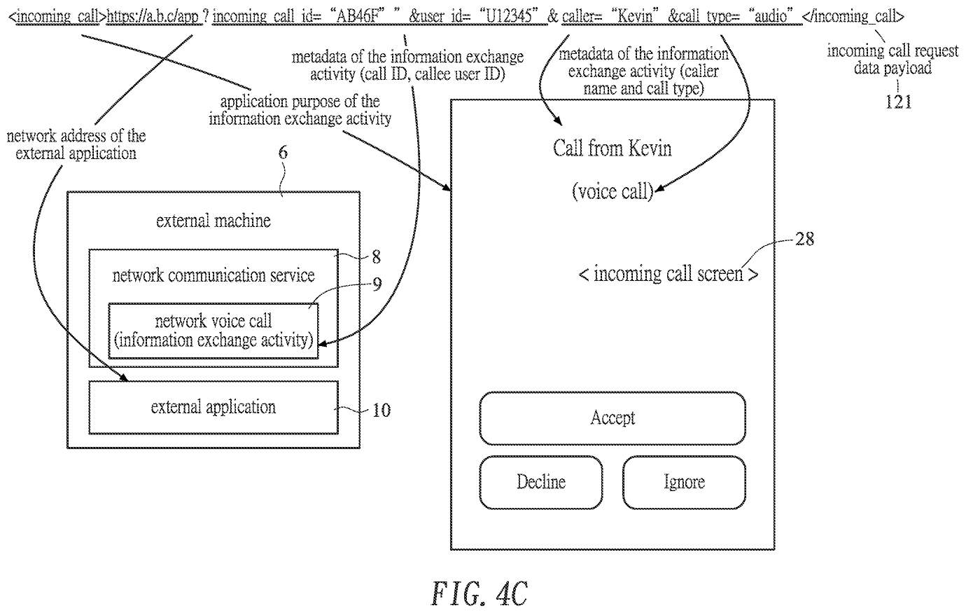

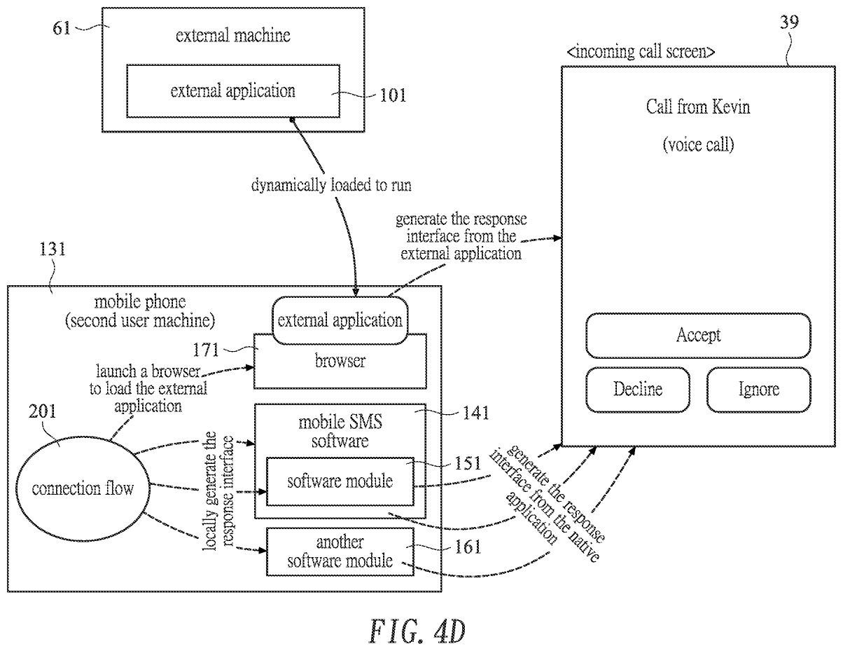

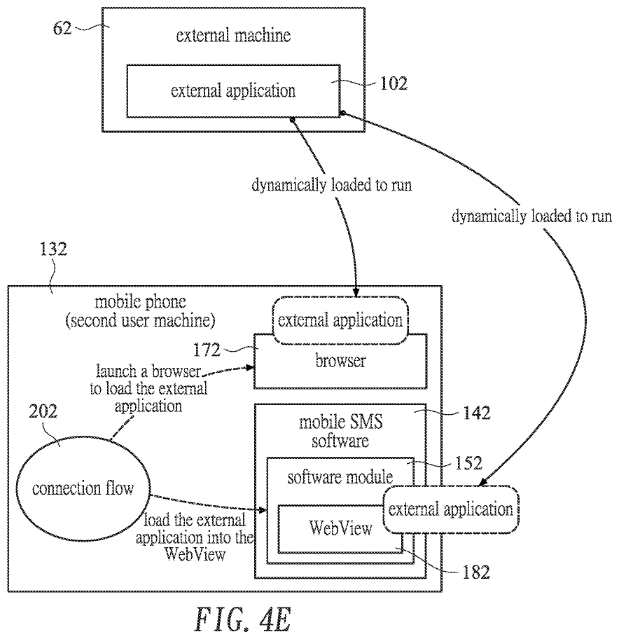

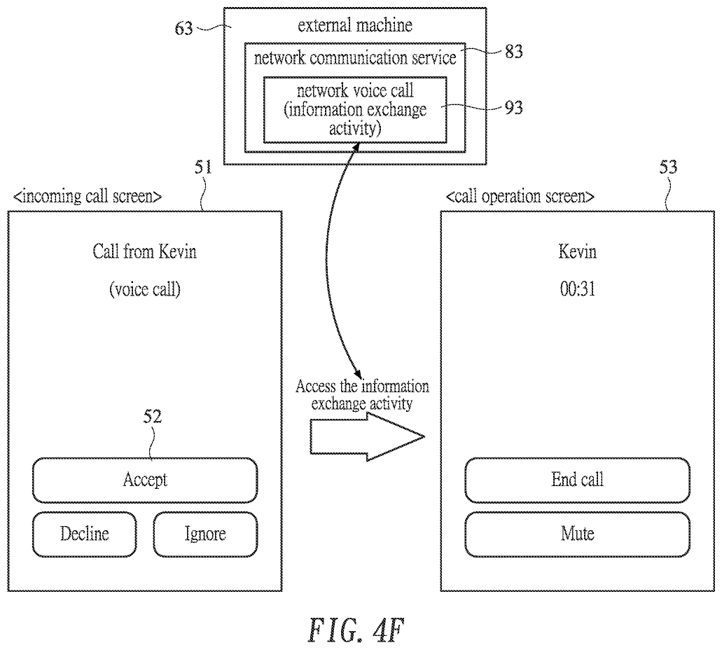

A method for dynamically connecting a volatile network communication channel based on the network configuration of FIG. 3 will be illustrated as follows. The operating concepts will be illustrated with reference to FIGS. 4A to 4F. The external machine 6, 61, 62 or 63 as shown in FIGS. 4A to 4F is the same as or equal to the external machine 1 as shown in FIG. 3. The external application 10, 101 or 102 as shown in FIGS. 4A to 4F is the same as or equal to the external application 5 as shown in FIG. 3. The network communication service 8 or 83 as shown in FIGS. 4A to 4F is the same as or equal to the network communication service 3 as shown in FIG. 3.

Firstly, please refer to FIG. 4A. A computer 7 is a first user machine. The caller has already imported the external application 10 into the computer 7 through the online application store. Consequently, the caller can directly activate the external application 10 on the desktop management of the computer 7. After a mobile phone number is inputted through a voice call dialing interface provided by the external application 10, the external application 10 issues an HTTP request to the network communication service 8 to request the network communication service 8 to dial another user (the callee) who has the mobile phone number. After receiving the HTTP request, the network communication service 8 generates an entity of the network voice call 9 and provides a call ID for the entity (i.e., the network voice call 9 is an information exchange activity). In addition, the network communication service 8 provides a temporary user ID for the callee. Then, the network communication service 8 generates an incoming call request 12. The incoming call request 12 is an information exchange request. The incoming call request 12 is able to be sent through an e-mail, a mobile short message (SMS), a mobile push notification (e.g., Push Notification), a remote procedure call or any third-party information transmission channel. Moreover, the computer equipment with networking and computing capabilities can support any third-party information transmission channel and receive and process the incoming call request 12. Consequently, the machine used for receiving the information exchange activity is a handheld computer, a desktop computer, a smart TV or any computer equipment with networking and computing capabilities. Moreover, depending on the requirement of the third-party information transmission channel used, the incoming call request can be sent after all the information contents are wrapped as a data payload, or the incoming call request is sent by dividing various information contents into plural parameters according to an interface declaration of the remote procedure call. In this embodiment, the incoming call request 12 is sent through a short message service (SMS) channel. Consequently, after the incoming call request 12 is processed as a data payload of text contents by the network communication service 8, the incoming call request 12 is sent to a mobile phone 13 corresponding to mobile phone number through a SMS gateway 11 as the SMS channel. The mobile phone 13 is the mobile phone used by the callee (i.e., the mobile phone 13 is the second user machine). The operating system used by the mobile phone 13 is an Android operating system. The incoming call request 12 may be regarded as an ordinary call-answering invitation to the callee when the network voice call 9 is established, or the incoming call request 12 may be regarded as an emergency call notification that requires the immediate access by the callee.

When the network communication service 8 generates a short message content of the incoming call request 12, the short message content is generated with a recognizable information structure (i.e., the data structure of the information exchange request). The short message content contains a link that is used to point to the network address of the external application. At the same time, the relevant metadata of the network voice call 9 (including the call ID, the user ID of the callee, the name of the caller, and a call type) in the parameter form of URL Query Parameter is added to the link. For example, the <incoming_call> tag in the information structure is identified. When the short message content of the incoming call request 12 is generated according to the information structure, the receiver of the short message content can unambiguously identify the short message content according to the information structure and recognize it as incoming call request. An example of the short message content is shown as follows:

<incoming_call>
https://a.b.c/app?incoming_call_id=“AB46F”&user_id=“U12345”&caller=“Kevin”&call_type=
“audio”
</incoming_call>

Please refer to above embodiment and also refer to FIG. 4B. FIG. 4B schematically illustrates an operating concept of installing or importing the external application 10 into the mobile phone 13 as shown in the embodiment of FIG. 4A. In the embodiment of FIG. 4A, the computer 7 of the caller has imported the external application 10. Consequently, the computer 7 can directly activate the external application 10 and connect a network communication channel to the network communication service 8 for dialing. However, in accordance with the conventional method, the callee has not previously installed or imported the external application 10 into the mobile phone 13 used by the callee. In a method of the conventional technology for solving this problem, the callee is only be able to see the text message content of the incoming call request 12 from a mobile SMS software 14 of the mobile phone 13. The mobile SMS software 14 is a software system. Conventionally, in many situations, the callee must wait for confirmation before deciding whether to install or import the external application 10 to answer the network voice call 9. In fact, regardless of whether the incoming call request 12 is sent through a short message service, an e-mail, a Facebook dynamic post or a Whatsapp chat message with a network link, the man-machine interface template of the man-machine operation interface generated in response to the incoming call request 12 is not designed according to the applied use of the incoming call request 12. Since the conventional technology lacks the effective instant response interface and the effective guidance, it brings a great inconvenience to the access of the instant information exchange activities.

For solving the above problem, the embodiment as shown in FIG. 4B provides a software module 15 in the mobile SMS software 14. When the mobile SMS software 14 receives a short message from a short message service channel of a telecommunication network, the short message content is transmitted to the software module 15. Generally, there are many methods of transmitting the short message content from the mobile SMS software 14 to the software module 15. Some of these methods will be described as follows. Firstly, the emobile SMS software 14 calls a function provided by the software module 15, and then sends the short message content to the software module 15 in the form of function parameters. Secondly, the program block of the software module 15 can be directly embedded in the function of the mobile SMS software 14 for receiving the short message content, and the program block of the software module 15 can be included in the function to directly receive the short message content. Thirdly, the mobile SMS software 14 provides a short message reading function for reading the short message content. Then, an event is triggered to notify the software module 15 in an event-driven manner. Then, the software module 15 calls the short message reading function to receive the short message content. It is noted that the data transmission docking method and the data interaction method between different software systems and/or different software modules during the execution are not restricted. The technologies about various data transmission docking methods and data interaction methods are very popular. That is, those skilled in the art can make any equal design changes based on actual application requirements.

In addition, there are many methods for the data integration of the mobile SMS software 14 and the software module 15. Hereinafter, some of the data integration methods will be described.

Firstly, the mobile SMS software 14 sends the short message contents of all short messages to the software module 15, and the software module 15 recognizes whether any of the short messages is an incoming call request according to the result of judging whether the short message content is marked with <incoming_call></incoming_call>. If the short message is not an incoming call request, the software module 15 does not do any processing operation. Whereas, if a short message is a recognizable incoming call request, the software module 15 reads the short message content of the short message to the memory and then notifies the mobile SMS software 14 of deleting the short message.

Secondly, the task of recognizing whether the short message is the incoming call request can be executed by the mobile SMS software 14 itself. The short messages that are not the incoming call requests are filtered off for the software module 15 by the mobile SMS software 14 actively. That is, only the short messages confirmed as the incoming call requests will be transmitted from the mobile SMS software 14 to the software module 15.

Thirdly, in a further method, the mobile SMS software 14 can not only screen out the short messages that are determined to be incoming call requests for the software module 15, but also decode and/or analyze the contents of the text messages for the software module 15 in advance. For example, before the short message content of the incoming call request is sent to the software module 15, the mobile SMS software 14 can firstly retrieve the network address, the call ID, and the user ID of the callee that point to the external application 10. Then, it is not necessary to completely send the short message content in the form of a data payload. Instead, the information parsed by the mobile SMS software 14 can be sent to the software module 15 in the form of function parameters. Consequently, it is not necessary for the software module 15 to do any decoding and/or analyzing operation on the short message content.

It is noted that the methods for the data integration of the mobile SMS software 14 and the software module 15 are not restricted. The technologies about various data integration methods are very popular. That is, those skilled in the art can make any equal design changes based on actual application requirements.

In an embodiment, before the network communication service 8 submits the incoming call request 12 to the SMS Gateway 11, the data payload can be transmitted in the form of an unencoded plain text, or the data payload can be encoded and then transmitted. For example, the mobile SMS software 14 can define and support an open standard encoding format. Consequently, the mobile SMS software 14 can not only receive the original unencoded short message content but also receive the short message content that is encoded in the standard encoding format. If the incoming call request 12 is an encoded short message content, after the incoming call request 12 is transmitted to the mobile SMS software 14, the short message can be decoded during the data transmission and docking process between the mobile SMS software 14 and the software module 15. For example, the incoming call request 12 is firstly decoded by the mobile SMS software 14. After the decoding process is completed, the original unencoded data of the decoded incoming call request 12 is transmitted from the mobile SMS software 14 to the software module 15. Alternatively, the encoded short message content is directly transmitted to the software module 15. After the encoded short message content is decoded by the software module 15, the original unencoded data of the decoded incoming call request 12 is acquired. As mentioned above, the information exchange request is transmitted in an uncoded or encoded data payload. If the data payload is an encoded data payload, the encoded data payload is decoded during the data transmission and docking process, or the encoded data payload is decoded by the software system or the software module. The method of decoding the encoded data payload is not restricted. Any program block executed in the data transmission and docking process can decode the encoded data payload in the same or equal way.

When the software module 15 receives the physical content of the incoming call request 12, the software module 15 triggers the activation of a connection flow 20 to process the incoming call request 12. The connection flow 20 is an operating process initiated by a program block. The software module 15 can trigger the activation of the connection flow 20 through the direct reference of the program block, a function call to the program block, an event-driven method or any method that can trigger the execution of a program block.

Please refer to the above embodiments and also refer to FIG. 4C. FIG. 4C schematically illustrates an incoming call request data payload 121 as an example of the short message content of the incoming call request 12 as shown in FIG. 4A. From the data payload 121 of an incoming call request, a link can be parsed programmatically. The link is https://a.b.c/app?incoming_call_id=“AB46F”& user_id=“U12345”&caller =“Kevin”&call_type=“audio”. After the link is further parsed, the parse result indicates that the network address of the external application 10 is “https://abc/app”, the call ID is “AB46F”, the user ID of the callee is “U12345”, the caller name is “Kevin” and the call type is a “audio voice call”. The data including the call ID, the user ID, the caller name and the call type is a set of metadata of the network voice call 9. In the set of metadata, the information including the caller name and the call type is the information that can be recognized to generate an incoming call screen 28. The incoming call screen 28 is a response interface. The set of metadata is embedded in the link in the parameter form of URL Query Parameter. Consequently, when the external application 10 is dynamically loaded to run through the browser or the WebView, the external application 10 that is dynamically loaded to run in the browser or the Web View can acquire the set of metadata of the network voice call 9 from the URL Query Parameter. Moreover, after the external application 10 connects a network communication channel to the network communication service 8 according to the call ID “AB46F” and the user ID “U12345” in the set of metadata, the external application 10 is served as the callee to access the network voice call 9 that is pointed by the call ID. Moreover, according to the contents of the set of metadata, the incoming call screen 28 suitable for the application of the incoming call request 12 can be generated. <incoming_call></incoming_call> indicates the application purpose of the incoming call request 12. Consequently, the incoming call screen 28 can be generated, and the caller name, the call type or any other appropriate information can be correctly displayed on the incoming call screen 28. At the same time, an incoming call ringtone is enabled and/or the mobile phone is switched to a vibration mode. Consequently, the callee can have a good knowledge of the arrival of the network voice call 9 more immediately and guide the callee to press “Accept” to access the network voice call 9. The man-machine interface of the incoming call screen 28 (i.e., the response interface) displays a visual operation interface. In order to ensure that the callee's attention is effectively obtained, it is also possible to selectively decide whether to notify the callee through the mobile phone ringtone or the mobile phone vibration. The answer button is used as an operable window component. The answer button in the man-machine interface of the incoming call screen 28 (i.e., the response interface) also provides a confirmation intention to guide the user to access the network voice call 9 (i.e., the information exchange activity). In accordance with the method of this embodiment, the incoming call screen 28 of the network voice call 9 can be effectively generated. Unlike the network address displayed by URL, “Accept” is a confirmation button that guides the callee to access the network voice call 9. In response to the connection flow 20 of different selected operating paths, the trigger method of accessing the network voice call 9 can be packaged into the event handling function of its own button by the incoming call screen 28. The implementation method of the different operation paths of the connection flow 20 will be fully explained as follows.

In an implementation example of the present invention, when the external application 10 issues the incoming call request 12 (i.e., the information exchange request) or when the information exchange request is sent, the external application 10 and the supplier of the external application 10 do not need to previously register a transmission identification code for receiving the incoming call request 12 in the mobile phone 13 (i.e., the callee) to the SMS Gateway 11 (i.e., a third-party information transmission channel), the SMS software 14 (i.e., a third-part software system) and/of the software module 15. Consequently, a technical benefit is generated. That is, even if the external application 10 has not been executed on the mobile phone 13 and the supplier of the external application 10 has not made any settings on the third-party transmission channel or the mobile phone 13, the caller of the mobile phone 13 can make a call to the callee and complete the information exchange through the external application 10. Depending on the type of the third-party message transmission channel, the transmission identification code is a token for a Push Notification/Push Service or any identification code for tracking a transmission relationship between the external application and the information exchange request. The definitions of the Push Notification/Push Service can be referred to the following webpage at “https://www.raywenderlich.com/11395893-push-notifications-tutorial-getting-started”.

In an embodiment, the data payload of the incoming call request is constituted in a different method. Some examples of the method of constituting the data payload will be described as follows.

Firstly, the link contained in the incoming call request data payload can be provided in the form of a “code”. For example, if the network communication service 8 or the information exchange activity provided by the network communication service 8 is a public and globally well-known network service, the phone operating system of the callee can add a data record in the database in advance according to the brand advantage of the brand network communication service 8. In the database, the network address “https://a.b.c/app” of the external application 10 is mapped to a code “abc_incoming_call”. Consequently, the short message content of the incoming call request 12 can actually be adjusted to:

<abc_incoming_call>
<incoming_call_id>AB46F</incoming_call_id>
<user_id>U12345</user_id>
<caller>Kevin</caller>
<call_type>audio</call_type>
</abc_incoming_call>

When a software system in the phone operating system of the callee receives the short message content, the network address “https://a.b.c/app” of the external application 10 corresponding to the “abc_incoming_call” can be found by querying the database. After the communication ID, the caller name, the call type and other information in the short message content are combined, the network address for dynamically loading and running the external application can be assembled by the software system in a string composition manner. For example, the network address is https://a.b.c/app?incoming_call_id=“AB46F”&user_id=“U12345”&caller=“Kevin”&call_type=“audio”.

Secondly, in a further design, the phone operating system of the callee can use the data record in the database to map “https://a.b.c/app” to “abc_incoming_call” and also map the data record to another code, i.e., the phone number bound to the SMS Gateway 11 of the network communication service 8. Consequently, the short message content from the incoming call request 12 can be adjusted to:

<incoming_call_id>AB46F</incoming_call_id>
<user_id>U12345</user_id>
<caller>Kevin</caller>
<call_type>audio</call_type>

When the software system in the phone operating system of the callee receives the short message content, the software system can query the corresponding network address “https://a.b.c/app” of the external application 10 according to the sender phone number of the short message content. In the above two methods, “abc_incoming_call” and “the sender phone number of the short message content” are codes that can be used to identify (locate) the network address pointing to the external application.

If the network communication service 8 has an HTTP API for the software system to call (the HTTP API is also written in the data record of the database), after the HTTP API receives a call ID, the HTTP API returns the metadata of the network voice call pointed by the call ID, the short message content can even be adjusted to:

The software system can query the database through the sender mobile phone number. From the database record, the sender mobile phone number corresponds to abc_incoming_call. That is, the application purpose of the short message is an incoming call request. Moreover, the software system can find the HTTP API from the data record and retrieves the metadata of the network voice call pointed by the call ID by calling the HTTP API. Then, the network address for dynamically loading and running the external application is assembled. The network address is https://a.b.c/app?incoming_call_id=“AB46F”&user_id=“U12345”&caller=“Kevin”&call_type=“audio”.

As mentioned above, the information exchange request (e.g., the incoming call request) is identified according to the following methods. If the data payload of the information exchange request (e.g., a short message content) is generated according to a standard information structure (i.e., the data structure of the information exchange request), the data payload can be identified according to the data structure and correctly recognized as an information exchange request (e.g., an incoming call request). Alternatively, if the data payload of the information exchange request (e.g., a short message content) is transmitted through an exclusive information transmission channel, for example the sender uses a public and exclusive phone number to send the short message, the data payload can be identified according to the phone number of the sender and correctly recognized as an information exchange request (e.g., an incoming call request). Alternatively, if the content of the data payload of the information exchange request (e.g., a short message content) contains an exclusive code (also referred as a service identification code) representing the network communication service, the information exchange activity or the external application, the data payload can be correctly recognized as an information exchange request (e.g., an incoming call request) according to the exclusive code.

It is noted that the method of using the code to confirm the network address of the external application is not restricted. The method of recognizing the code for a network address is very popular. In addition, those skilled in the art can make any equal design changes based on actual application requirements.

Please refer to the above embodiments and also refer to FIG. 4D. FIG. 4D schematically illustrates the operating concepts of the method for dynamically connecting the volatile network communication channel according to another embodiment of the present invention. The mobile phone 131 as shown in FIG. 4D is the same as or equal to the mobile phone 13 as shown in FIG. 4B. The connection flow 201 as shown in FIG. 4D is the same as or equal to the connection flow 20 as shown in FIG. 4B. The mobile SMS software 141 as shown in FIG. 4D is the same as or equal to the mobile SMS software 14 as shown in FIG. 4B. The software module 151 as shown in FIG. 4D is the same as or equal to the software module 15 as shown in FIG. 4B. The incoming call screen 39 as shown in FIG. 4D is the same as or equal to the incoming call screen 28 as shown in FIG. 4C. The activation of the connection flow 201 triggered by a program block. During the operating process of the connection flow 201, there are some different methods of generating the incoming call screen 39 for the callee to operate:

Firstly, the man-machine operation interface of the incoming call screen 39 can be provided by the mobile SMS software 141, the software module 151, or another software module 161 which is executed in the mobile phone 131 and implemented with an Android Activity. The associated technologies of the Android Activity can be referred to: https://developer.android.com/reference/android/app/Activity. Moreover, an Android Intent for a receiving request of the Android Activity (as an event trigger for the incoming call notification) is registered. Consequently, other software systems can drive the execution of the Android Activity by issuing an event entity of the Android Intent. After the program block for triggering the activation of the connection flow 201 wraps the incoming call request data payload 121 into the event entity of the Android Intent, the event entity of the Android Intent is issued through the Android operating system, and the request of the event entity of the Android Intent will be received by the Android Activity and driven to execute. Then, after the contents of the incoming call request data payload 121 wrapped in the event entity of the Android Intent are injected into a man-machine interface template suitable for the application purpose of the incoming call request 12 by the Android Activity, the incoming call screen 39 is generated and displayed on the display screen of the mobile phone. The Android Activity can also simultaneously play a ringtone of a mobile phone call and/or drive the mobile phone 131 to enter a vibration mode. The display data (e.g., the caller name and the call type) required to generate the incoming call screen 39 are included in the event entity of the Android Intent in the form of parameters along with the content of the incoming call request data payload 121 when the event entity of the Android Intent is issued, and then transmitted to the Android Activity. The man-machine interface template of the incoming call screen 39 is provided and applied by the Android Activity that implements the man-machine operation interface when the incoming call screen 39 is generated.

Secondly, the man-machine operation interface of the incoming call screen 39 can also be generated by the external application 101. The program block that triggers the activation of the connection process 201 can directly use a browser 171 to open the network address in the incoming call request data payload 121 through the following code, and dynamically load and run the external application 101 in the browser 171. When the external application 101 starts to be executed, the incoming call screen 39 can be generated on the display screen of the mobile phone according to the content of the metadata in the URL Query Parameter. The man-machine interface template of the incoming call screen 39 is provided and applied by the external application 101 when the incoming call screen 39 is generated.

```
  val openURL = Intent(android.content.Intent.ACTION_VIEW);
  openURL.data = Uri.parse(“https://a.b.c/app?
incoming_call_id=“AB46F”&user_id=“U12345”&caller=“Kevin”&call_ty
pe=“audio””);
  startActivity(openURL);
```

It is noted that the above method of generating the response interface (e.g., the incoming call screen) during the operation of the connection flow is only a non-limiting embodiment. The method of generating the response interface for the information exchange activity (e.g., the network voice call) is not restricted. In addition, those skilled in the art can make any equal design changes based on actual application requirements.

Please refer to the above embodiments and also refer to FIG. 4E. FIG. 4E schematically illustrates the operating concepts of the method for dynamically connecting the volatile network communication channel according to another embodiment of the present invention. The mobile phone 132 as shown in FIG. 4E is the same as or equal to the mobile phone 13 as shown in FIG. 4B. The connection flow 202 as shown in FIG. 4E is the same as or equal to the connection flow 20 as shown in FIG. 4B. The mobile SMS software 142 as shown in FIG. 4E is the same as or equal to the mobile SMS software 14 as shown in FIG. 4B. The software module 152 as shown in FIG. 4E is the same as or equal to the software module 15 as shown in FIG. 4B.

Firstly, the external application 102 can be dynamically loaded to run through the browser 172. After the dynamic loading operation is completed through the browser 172, the external application 102 runs in the system process (i.e., OS process) of the browser 172. For the mobile SMS software 142, the browser 172 is another independently running software system that is triggered during the operation of the connection flow 202. The “task of activating the browser 172 to dynamically load and run the external application 102” can be triggered by the program block that activates the connection flow 202 or the program block that executes the incoming call screen 39.

Secondly, a Web View is triggered to dynamically load and run the external application 102 during the operation of the connection flow 202. Consequently, the external application 102 can run in the same system process (OS process) as the software module 152. A method of achieving this purpose will be described as follows. Firstly, an Android Activity embedded with a WebView 182 is provided in the software module 152. The Web View is a software system that provides an HTML/CSS/Javascript software engine, which can be embedded in the Android Activity in the form of a component-based software system. The WebView provides the ability to dynamically load and run the Web front-end applications for the Android Activity. When compared with the Android Activity native application, the Web front-end application is a heterogeneous system. Then, an Android Intent for a receiving request of the Android Activity (as an event trigger for dynamically loading the notification) is registered. The Intent is responsible for receiving a triggering instruction during the operation of the connection flow 202 in order to dynamically load and run the external application 102 in the WebView 182. For the mobile SMS software 142, the WebView 182 is another component-based software system that is triggered during the operation of the connection flow 202. The “task of activating the WebView 182 to dynamically load and run the external application 102” can be triggered by the program block that activates the connection flow 202 or the program block that executes the incoming call screen 39.

Regardless of whether the external application 102 is dynamically loaded through the browser 172 or the WebView 182, the external application 102 does not need to be installed or imported into the mobile SMS software 142, the browser 172, the WebView 182 or the mobile phone 132.

Please refer to the above embodiments and also refer to FIG. 4F. FIG. 4F schematically illustrates the operating concepts of the method for dynamically connecting the volatile network communication channel according to another embodiment of the present invention. The network voice call 93 as shown in FIG. 4F is the same as or equal to the network voice call 9 as shown in FIG. 4A. The incoming call screen 51 as shown in FIG. 4F is the same as or equal to the incoming call screen 39 as shown in FIG. 4D. The incoming call screen 51 generated during the operation of the connection flow 201 is a guide interface for the callee. When the mobile phone ringtone is enabled and/or the mobile phone is switched to a vibration mode, the callee can have a good knowledge of the incoming call request of the network voice call 93 more immediately and guide the callee to access the network voice call 93. When the callee presses “Accept” 52 on the incoming call screen 51, the following two methods can be used to access the network voice call 93.

Firstly, if the incoming call screen 51 is generated by the external application 101, it means that the external application 101 has been dynamically loaded to run on the browser 171 and the call ID and callee user ID of the network voice call 93 can be retrieved through the URL Query Parameter. Consequently, the external application 101 instantly connects a network communication channel to the network communication service 83, and the external application 101 is served as a callee to access the network voice call 93 pointed by this call ID and answer the call. After the call is successfully answered, the callee can perform the instant voice call exchange with the caller.

For allowing the callee to have a better user experience, a single-page application architecture design is adopted. The associated technology of the single-page application architecture can be referred to https://en.wikipedia.org/wiki/Single-page_application. The incoming call screen 51 and the call operation screen 53 after accessing the network voice call 93 can be implemented on the same interface. That is, the incoming call screen 51 and the call operation screen 53 of the network voice call 93 can be integrated and displayed on the same interface for the user to operate. For example, after the user presses “Accept” 52, the “call time” appears on the display screen, and the relevant buttons are changed to the control buttons for the network voice call 93. In addition, if the network connection status is not good, it takes time to access the network voice call 93. Consequently, when the incoming call screen 51 is just generated, it is actually possible to simultaneously perform the accessing task of the network voice call 93 in the system background. After the accessing task is successfully done, the transmission of the voice signal stream is suspended first. After the callee confirms to answer the call, the transmission of the voice signal stream is then resumed. Consequently, the time period for the callee to wait for the network connection can be reduced.

Secondly, if the incoming call screen is generated by the mobile SMS software 141, the software module 151 or another software module 161 which is triggered during the operation of the connection flow 201, it means that the external application 101 has not yet been dynamically loaded. Consequently, when the user presses “Accept” 52, the browser 171 can be launched through the incoming call screen 51, or a Web View can be driven to dynamically load the external application 101. After the external application 101 is dynamically loaded to run, the call operation screen 53 of the network voice call 93 is displayed, and the external application 101 connects a network communication channel to the network communication service 83 in order to access the network voice call 93 to answer the call.

When the network voice call 93 (i.e., the information exchange activity) is accessed through the connection flow 201, the caller who initiates the network voice call 93 can communicate with the accessed callee in the network voice call 93 in order to collaboratively complete the instant access event corresponding to the incoming call request of the network voice call 93 (i.e., access the network voice call and make the instant communication exchange).

It is noted that the above embodiments are presented herein by using the network voice call as an example. These embodiments are non-limiting embodiments. The ways of importing the method of the present invention through various software services with the dynamic loading capability are not restricted. In addition, those skilled in the art can make any equal design changes based on actual application requirements.

In the above embodiments, the browsers and the Web Views in different operating systems may be different in compatibility. Consequently, it is preferred that the external application can provide different compatible versions for different browsers, software platforms or operating systems and they can be published on different machines on the network and directed by different network addresses. When the external application is dynamically loaded, the network address determined by the link in the information exchange request can firstly point to a proxy server. When the mobile phone browser submits a dynamically loaded HTTP Request to the proxy server through the network address, the proxy server can determine which network address (i.e., another network address) should be redirected according to the information associated with the mobile phone operating system in the HTTP Request. Consequently, the most compatible external application can be dynamically loaded to run via another network address. If the one pointed by the network address has been already a compatible external application, the network address does not need to be redirected.

In the above embodiments, for meeting the load balancing need, the same external application can also be published on different machines on the network and pointed by different network addresses. The network address determined by the link in the content of the information exchange request can firstly point to a proxy server. The proxy server determines which network address (i.e., another network address) should be redirected according to the load information that is grasped by the proxy server. Consequently, the external application to be dynamically loaded to run via another network address, and the corresponding service is provided by the machine with the lower load. If the service has been already provided by the machine with the lower load via a network address, this network address does not need to be redirected.

Moreover, in order to allow the dynamic loading load of external application to be controlled easier, the startup module of the external application can be stored in a storage medium as a cache during the dynamic loading process. In the subsequent dynamic loading process corresponding to other information exchange activities, the startup module of the external application can be dynamically loaded from the cached storage medium. Consequently, the dynamic loading efficiency is enhanced.

It is noted that the above methods and scenarios for redirecting the network address of the external application are only non-limiting examples. The methods and scenarios for redirecting the network address of the external application are not restricted. In addition, those skilled in the art can make any equal design changes based on actual application requirements.

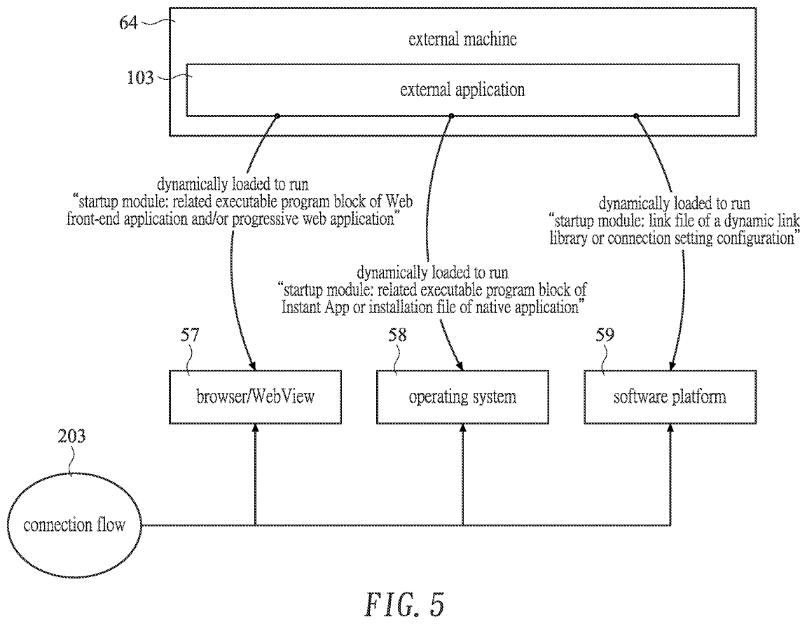

From the above embodiments, the present invention provides at least five methods to dynamically load and run software services through a network address. The software services include Web systems, native applications, and RemoteApp. In addition, the software service that is dynamically loaded to run can connect a network communication channel and access an information exchange activity according to the metadata content of the information exchange request sent in the form of parameters. Consequently, the network communication service can provide different compatible versions of external applications for various browsers, software platforms, operating systems or other terminal systems. Different compatible versions of external applications can be deployed on different machines, published in different domains (Domain Name), and pointed by different network addresses. Alternatively, different compatible versions of external applications can be published on the same machine and pointed by different network addresses of the same domain name. FIG. 5 schematically illustrates the operating concepts of the method for dynamically loading different compatible versions of external applications that can be used in all embodiments of the present invention. In an external machine 64, different compatible versions of external applications 103 are deployed. The different compatible versions of external applications 103 includes a Web system, an Android native application, a dynamic link library and a RemoteApp. In addition, the startup module of each external application 103 is published in the external machine 64. The startup module includes a related executable program block (related program code) of a Web front-end application and/or a progressive web application, a related executable program block (related program block) of an Android Instant App, an installation file of an Android native application, a link file of a dynamic link library and an import file of a RemoteApp connection setting configuration. The startup module of each external application is pointed by different network addresses that share the same domain. In the present invention, the activation of the connection flow 203 is triggered by the software module. During the operation of the connection flow 203, the external application is dynamically loaded to run via the network address pointed by the link in the content of the information exchange request. If the network address points to the related executable program block (related program code) of the Web front-end application and/or the progressive web application, the dynamical loading task is performed through a browser or a Web View. If the network address points to the related executable program block of the Android Instant App or the installation file of the Android native application, the dynamical loading task is performed through the adb tool provided by the Android operating system. If the network address points to the dynamic link library or the import file of the RemoteApp connection setting configuration, the corresponding software platform (e.g., mstsc) can be driven to perform the dynamical loading task. In the operation process of dynamically loading and running an external application, during the operation of the connection flow in one machine, the startup module of the external application is loaded from another machine and then the service provided by the external application is enabled in the machine. Consequently, the machine connects the network communication channel corresponding to the information exchange request through the service and accesses an information exchange activity. For example, in the embodiments of FIGS. 4A to 4F, the external application 10, 101 or 102 can be the Web system, the native application or any software service that can be dynamically loaded to run by the various startup modules as shown in FIG. 5.

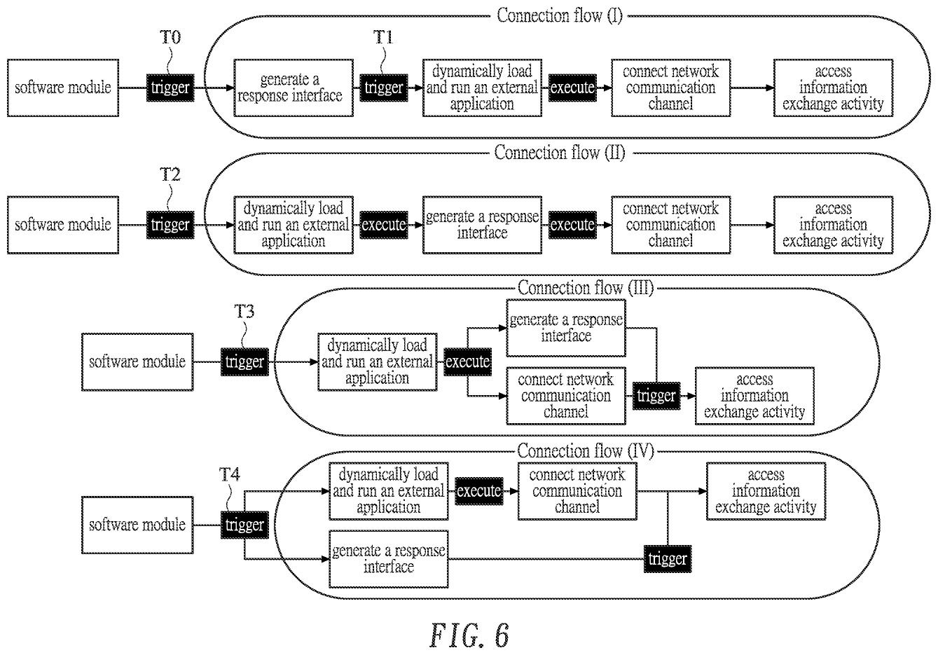

Please refer to the above embodiments and also refer to FIG. 6. FIG. 6 schematically illustrates the operating concepts of various operating paths of the connection flows in FIGS. 4D to 4F. In this context, the “connection flow” is a work process that starts with a procedure of “allowing a software module to trigger the execution of a program block for dynamically connecting a volatile network communication channel” and ends with a procedure of “accessing to an information exchange activity”. The operations of the work process can be adaptively adjusted on the path according to the user's operating experience. Take the examples of FIG. 4A to FIG. 4F and FIG. 6 for example. The operating process of the connection flow at least comprises four paths.

The connection flow (I) will be described as follows. When a software module receives an incoming call request (i.e., an information exchange request) corresponding to a network voice call (i.e., an information exchange activity), the connection flow is activated through a triggering execution TO on a program block. During the execution process of the program block, the incoming call request is wrapped in an Android Intent entity (as an event trigger for the incoming call notification), and the Android Intent entity is issued to drive the execution of an Android Activity. During the execution of the Android Activity, an incoming call screen (i.e., a response interface) is generated according to the content of the incoming call request so as to be operated by the user. After the user presses “Answer” on the incoming call screen, the Android Activity performs an additional triggering execution T1 on an additional program block to dynamically load and run a progressive web application (i.e., an external application). During the execution of the additional program block, a browser is activated, and the network address of the external application and the metadata of the network voice call are transmitted to the browser in the form of URL Query Parameter. Consequently, the progressive web application is dynamically loaded to run in the browser. After the progressive web application is dynamically loaded to run in the browser, the progressive web application connects a network communication channel to the network communication service and accesses the network voice call according to the metadata of the network voice data (e.g., a call ID and a user ID).

The connection flow (II) will be described as follows. When a software module receives an incoming call request (i.e., an information exchange request) corresponding to a network voice call (i.e., an information exchange activity), the connection flow is activated through a triggering execution T2 on a program block. During the execution process of the program block, a browser is activated, and the network address of a progressive web application (i.e., an external application) and the metadata of the network voice call are transmitted to the browser in the form of URL Query Parameter. Consequently, the progressive web application is dynamically loaded to run in the browser. After the progressive web application is dynamically loaded to run in the browser, the progressive web application generates an incoming call screen (i.e., a response interface) for the incoming call request. After the user presses “Answer” on the incoming call screen, the progressive web application connects a network communication channel to the network communication service and accesses the network voice call according to the metadata of the network voice data (e.g., a call ID and a user ID). In addition, the incoming call screen and the network voice call can be mixed in the progressive web application.

The connection flow (III) will be described as follows. When a software module receives an incoming call request (i.e., an information exchange request) corresponding to a network voice call (i.e., an information exchange activity), the connection flow is activated through a triggering execution T3 on a program block. During the execution process of the program block, a browser is activated, and the network address of a progressive web application (i.e., an external application) and the metadata of the network voice call are transmitted to the browser in the form of URL Query Parameter. Consequently, the progressive web application is dynamically loaded to run in the browser. After the progressive web application is dynamically loaded to run in the browser, the progressive web application generates an incoming call screen (i.e., a response interface) for the incoming call request. In the system background, the progressive web application simultaneously connects a network communication channel to a network communication service according to the metadata of the network voice data (e.g., a call ID and a user ID). After the user presses “Answer” on the incoming call screen, the progressive web application accesses the network voice call. In addition, the incoming call screen and the network voice call can be mixed in the progressive web application.

The connection flow (IV) will be described as follows. When a software module receives an incoming call request (i.e., an information exchange request) corresponding to a network voice call (i.e., an information exchange activity), the connection flow is activated through a triggering execution T4 on a program block. During the execution process of the program block, the execution of an Android Activity is triggered to generate an incoming call screen (i.e., a response interface). In the system background, the network address of a progressive web application (i.e., an external application) and the metadata (in the form of URL Query Parameter) of the network voice call are simultaneously transmitted to a Web View. Consequently, the progressive web application is dynamically loaded to run in the WebView. After the progressive web application is dynamically loaded to run in the Web View, the progressive web application immediately connects a network communication channel to a network communication service. However, after the user presses “Answer” on the incoming call screen, the incoming call screen notifies the progressive web application in the WebView of the “already answered state” through PostMessage. Consequently, the procedure of accessing the network voice call is completed. In addition, the incoming call screen and the Web View can be mixed in the same Android App.

In FIG. 6, one program block can perform the triggering executions T0, T1, T2, T3 and T4 on the additional program block through various methods or the combination thereof. Some methods will be described as follows.

Firstly, the “program code of the additional program block” is directly imported into the “program code of the program block”, and the additional program block is directly executed in the program block.

Secondly, the “additional program block” is provided in a function, and the program block executes the “additional program block” in a synchronized function call manner. The function and the program block can be executed in the same OS process. Alternatively, the function and the program block can be executed in different OS processes or in different machines. For example, if the function and the program block are executed in different OS processes or in different machines, an interface for the Remote Procedure Call can be provided for the program block to call.

Thirdly, the program block, in an asynchronous event-driven manner, sends an event to notify a listener program of the event. Consequently, the “additional program block” is executed by the listener program. The listener program and the program block can be executed in the same OS process. Alternatively, the listener program and the program block can be executed in different OS processes or in different machines. For example, if the listener program and the program block are executed in different OS processes or in different machines, the event can be received through an interprocess communication or a socket connection. Moreover, after the event is received, the additional program block is executed.

Moreover, the procedure of triggering execution, the procedure of activating the connection flow, the procedure of generating the response interface and the procedure of dynamically loading and running the external application can be performed in the same OS process in the same machine, performed in different OS processes in the same machine, or performed in the same OS process or different OS processes in different machines.

It is noted that the method of triggering the execution of a program block is not restricted. The method of triggering the execution of an additional program block in a program block is very popular. In addition, those skilled in the art can make any equal design changes based on actual application requirements.

In an embodiment, the content of the information exchange request contains an access token for acquiring an authority of accessing the information exchange activity. In the embodiments of the network voice call as shown in FIGS. 4A to 4F, the identity authentication of the callee for the network voice call actually relies on the verification of the mobile short message (SMS). Only the mobile phone of the callee can receive the short message as an incoming call request. Then, the procedure of the identity authentication will be further performed. The network communication service can provide an access token in the incoming call request. The access token can be transmitted into the dynamically loaded external application in the form of URL Query Parameter along with other metadata of the network voice call. In addition, the access token can be used for recognizing that the authority of answering the network voice call is acquired. During the process of accessing the external application to the network voice call, the external application transmits the access token to the network communication service for authentication. When the network communication service confirms that the access token is issued by itself, the callee's request to access the network voice call is completed. Through the operation mechanism of the access token, the network communication service can cut off the dependence on mobile short message authentication. In addition, the overall authentication procedure is controlled by the network communication service. An example of an incoming call request with the access token will be described as follows.

<incoming_call>
https://a.b.c/app?incoming_call_id=“AB46F”&user_id=“U12345”&caller=
“Kevin”&call_type=“audio”&access_token=“X54GDFG”
</incoming_call>

In an embodiment, the information exchange request is issued by an authorized network communication service. By using the method of dynamically connecting the volatile network communication channel according to the present invention, the third-party information transmission channel, the software system, the software module or the connection process can authorize and manage the network communication service. According to the application purpose of the information exchange request, the information exchange activity provided by the network communication service is reviewed and the permission is corresponding determined. Consequently, the third-party authentication method can be used to filter information exchange requests for various application purposes by using the whitelist technical solution. If the permission of a certain network communication service does not allow to issue the information exchange request or an information exchange request for a specific application purpose, the third-party information transmission channel may cancel the transmission service of the information exchange request, the software system and the software module may refuse to trigger the corresponding connection flow for the information exchange request, or the connection flow may refuse to generate the response interface for the information exchange request.

In an embodiment, the information exchange activity is a message chat, a voice call, a video call, a web conference, an online sign-off activity or any online activity that can be accessed through a network connection. Some scenarios of the information exchange activity will be described as follows.

Firstly, a first user invites a second user to chat together through a network chat room service. After the first user makes a request to the network chat room service through a chat APP, the network chat room service creates a network chat room in the system and sends a chat invitation request to the second user via an e-mail. In the content of the chat invitation request, the network chat room service has placed a network address of the Android Instant App that can access the network chat room. In addition, the network chat room service has placed an access token of the network chat room, an inviter name and the chart room ID of the network chat room in the network address through URL Query Parameter. In the mobile phone of the second user, a software module is provided in an application. Moreover, an event notification that can monitor the “new mail received” is registered in an e-mail software in the mobile phone by the application. After the application receives the trigger of the event notification, the application requests the e-mail software to read a new mail, recognizes the content of the new mail as the chat invitation request, and transmits the new mail to the software module for processing. After the software module receives the chat invitation request, a connection flow is triggered. During the operation of the connection flow, another software module is triggered to generate an invitation interface to be operated by the second user according to the content of the chat invitation request. After the second user selects and confirms to enter the network chat room on the invitation interface, the Android Instant App is dynamically loaded to run through the network address. In addition, the Android Instant App connects a network communication channel to the network chat room service, and accesses to the network chat room to chat with the user through the chat room ID and the access token.

Secondly, a user makes a reservation for a Thailand travel plan on a travel website. In response to the reservation request, the travel website generates a reservation activity entity (i.e., the information exchange activity) in the back-end system. After several months, the Thailand travel plan will be officially launched. Consequently, the system sends a sign-off request (i.e., an information exchange activity) to the user through a mobile short message (SMS) according to the user's reservation activity entity in the system. The sign-off request contains a network address pointing to an external application (a progressive web application) for the sign-off of the reservation activity entity. The mobile SMS software on the user's mobile phone provides a software module for receiving the sign-off request. The software module checks the permission authority of the travel website operator. After the software module confirms that the permission authority of the travel website operator is able to issue and execute the sign-off request, the software module immediately activate a connection flow. The connection flow directly triggers the activation of a browser to open the network address. The browser dynamically loads the startup module of the external application through the network address (the relevant executable block of the progressive web application) through the network address. After the external application runs, the external application displays a sign-off guiding interface (i.e., a response interface). The screen of the sign-off guiding interface displays the sign-off requirements for the reservation activity and provides a “confirmation” button. After the user presses the “confirmation” button, the external application connects a network communication channel to access the sign-off interface of the reservation activity entity. According the Single-page Application technology, the electronic form for the relevant online sign-off and the sign-off guiding interface can be displayed on the same interface. After the user completes the electronic form, the required sign-off task is completed.

In an embodiment, the software system is a system firmware, an application, a software platform, a software engine, an operating system or any software system that can be extended by programs.

In an embodiment, the software module is provided in the software system in a form of a class library, a software component, a software agent, an application or any program code block that can run in the software system.

In an embodiment, the security authentication/confirmation mechanism between the callee and the caller can be implemented in the above embodiments of the present invention by using various existing related technologies.

In an embodiment, the content of the information exchange request is generated according to a structured protocol that the network communication service and/or the software module complies with, wherein the structured protocol is defined according to the declaration of a work process and/or a structured data format. In this context, the work process is a process combined of at least one information exchange activity through the mutual association of at least one executable state, wherein the association of at least one executable state is set in the information exchange request, or the association of at least one executable state is provided from the response information of the information exchange activity during the interaction procedure of the information exchange activity.

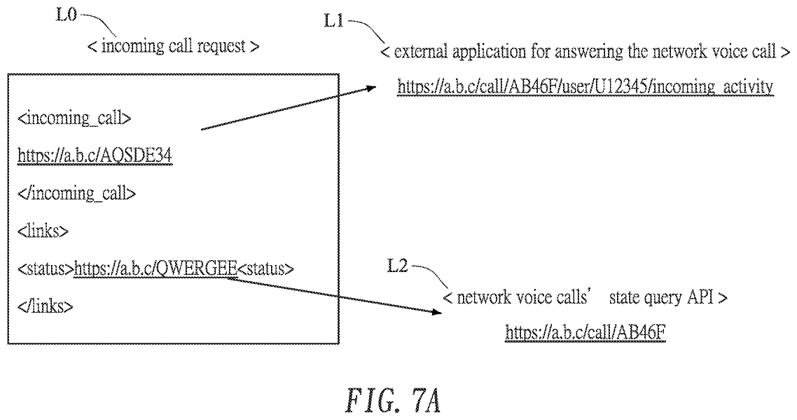

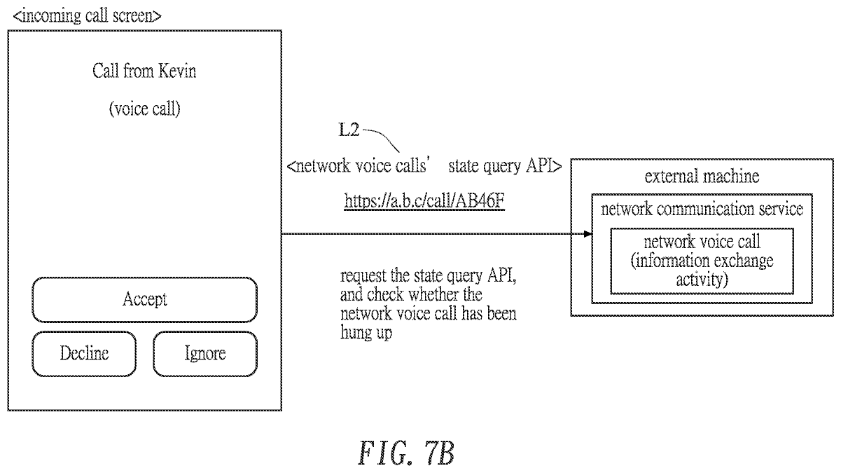

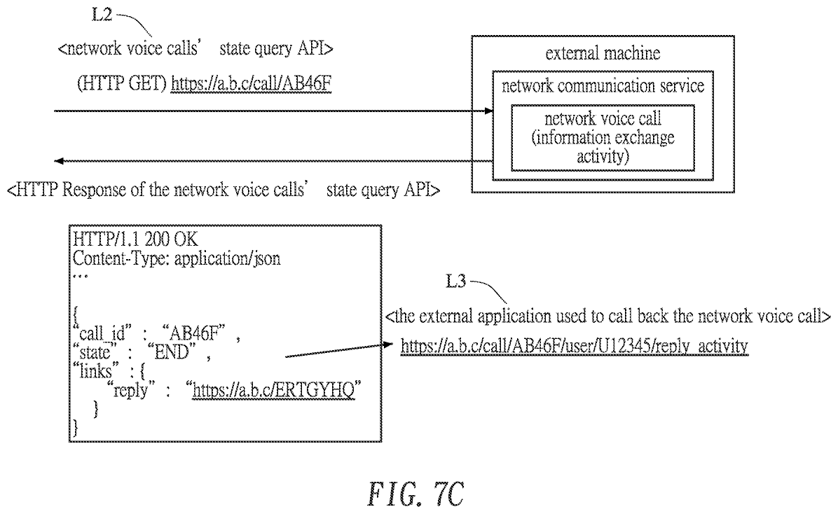

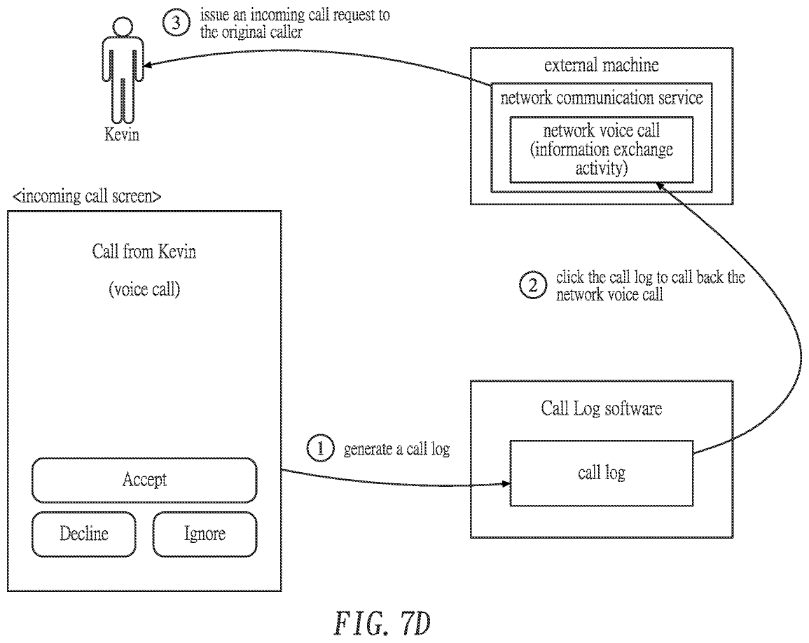

FIG. 7A schematically illustrates a concept of implementing the information exchange activity with a Hypermedia as the Engine of Application State (HATEOAS) according to an embodiment of the present invention. The associated technology of HATEOAS can be referred to the webpage at “https://en.wikipedia.org/wiki/HATEOAS”. A network voice calls can have different resource states. The current state of the network voice call will determine which operations can be performed on the network voice call. In FIG. 7A, an incoming call request L0 (i.e., an information exchange request) is taken as an example. When an incoming call request L0 is generated, the URL address L1 representing a resource that points to the external application for answering the network voice call is provided to the content of the incoming call request in a form of a shortened URL. In addition, according to the current state of the network voice call, the network voice call's state query API (L2) is injected into the incoming call request L0 in the form of a shortened URL.

When a software module receives the incoming call request L0 of FIG. 7A, the software module can realize how to process the current state of the network voice call from the information in the incoming call request L0. For example, the software module can realize how to answer the network voice call and detect the state of the network voice call.

Please refer to the above embodiments and also refer to FIG. 7B. FIG. 7B schematically illustrates an example of detecting the call state of the network voice call corresponding to FIG. 7A. Before the software module triggers the activation of a connection flow for the incoming call request L0, the software module may firstly submit an HTTP GET request through the network voice call's state query API (L2) to detect whether the network voice call has been hung up. If the network voice call has not been hung up by the caller, the software module will formally activate the connection flow for the incoming call request L0, or otherwise the connection flow will not need to be triggered. Moreover, during the operation of the connection flow, an incoming call screen (i.e., a response interface) is generated, and then the program of the incoming call screen is executed. Moreover, the software module may submit an HTTP GET request through the network voice call's state query API (L2). If the network voice call has been hung up by the caller, the incoming call screen should be ended.

Please refer to the above embodiments and also refer to FIG. 7C. FIG. 7C schematically illustrates an example of the response of the network communication service as shown in FIG. 7B to the call state detection. The network call service can allow the software module or the program executing the incoming call screen to obtain the current execution state of the network voice call through the HTTP Response of the state query API (L2). If the current state of the network voice call is “already hung up” (state=“END”), it means that the connection flow should be cancelled and the incoming call screen should be ended. In the HTTP Response, the information about the current state of the network voice call is included. In addition, the URL address L3 representing a resource of the external application used to call back the network voice call is also included in the HTTP Response. Consequently, the work process corresponding to the network voice call is dynamically imported into the machine running the software module.

Please refer to the above embodiments and also refer to FIG. 7D. FIG. 7D schematically illustrates an example of a call record for allowing the user to call back the network voice call as shown in FIG. 7C. After the software module or the program executing the incoming call screen detects that the network voice call has been hung up, the connection flow is cancelled, and the incoming call screen is ended. In addition, work process of calling back the network voice call can be dynamically imported into the machine according to the execution state of the network voice call. After the incoming call processing procedure of the network voice call is ended, the software module or the program executing the incoming call screen generates a call log in a call log software on the machine by means of function call or in an event-trigger manner. In addition, the URL address L3 representing a resource of the external application used to call back the network voice call is bound to the call log. When the user clicks on the call log in the call log software and makes a call back, the call log software triggers the activation of an additional connection flow. In the connection flow, an additional external application for calling back the network voice call is dynamically loaded to run according to the network address, the URL address L3, bound to the call log. After the additional external application is dynamically loaded to run, the additional external application connects a network communication channel to the network communication service to access the network voice call. In addition, the additional external application resends an incoming call request to the caller of the network voice call. Moreover, a call log bound to the network address of the external application for callback is provided in a program block of the call log software. When the callee clicks on the call log and makes a call back, the call log software triggers the activation of a connection flow, so that the external application for calling back the network voice call is dynamically loaded to run.

It is noted that the above methods and scenarios of dynamically importing the work process for the information exchange activities are non-limiting examples. The methods and scenarios of dynamically importing the work process for the information exchange activities are not restricted. In addition, those skilled in the art can make any equal design changes based on actual application requirements.

From the above descriptions, the present invention provides a method for dynamically connecting a network communication channel, a machine and a computer program product. The method, the machine and the computer program product have the following benefits.

Firstly, when compared with the existing technology, the information exchange request directed to the network communication channel can be identified. Consequently, the information security risk of the user encountering phishing attacks by unscrupulous persons through mobile short messages or e-mails can be effectively reduced.

Secondly, the information exchange requests directed to the network communication channels and their associated information exchange activities can be authorized to manage.

Thirdly, the information exchange request directed to network communication channel can be used to drive the dynamic loading of a work process.

Fourthly, the information exchange request directed to the network communication channel can be an instant information exchange event (i.e., an instant access event). When the receiver accesses the information exchange activity pointed by the information exchange event, the initiator of the information exchange activity can be simultaneously in the “accessing” state in order to conduct real-time information exchange together.

Fifthly, the dynamically loaded external application and the dynamically connected network communication channel can be volatile. That is, before and after the execution of the information exchange activity, the dynamically loaded external application and the dynamically connected network communication channel do not need to be directly built in, provided to or supported on the machine or device operated by the user.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A method for dynamically connecting a network communication channel in a software system, the method comprising steps of:
(i) providing a software module in the software system, and triggering activation of a connection flow in response to an information exchange request by the software module, wherein during the connection flow, a response interface corresponding to the information exchange request is generated for a user to operate according to a content of the information exchange request; and
(ii) guiding the user to perform a task of accessing an information exchange activity through the response interface, wherein task of accessing the information exchange activity is executed by an external application that is dynamically loaded to run, and the external application accesses the information exchange activity by connecting the network communication channel corresponding to the information exchange activity, wherein a content of the information exchange request contains a link that is used to point to a network address of the external application, and the external application is dynamically loaded to run through the network address during the connection flow.

2. The method according to claim 1, wherein the information exchange request is issued when the information exchange activity is established, an invitation of the information exchange activity is received and/or an instant access event of the information exchange activity is triggered.

3. The method according to claim 1, wherein the information exchange activity is a message chat, a voice call, a video call, a web conference, an online sign-off activity or any online activity that can be accessed through a network connection.

4. The method according to claim 1, wherein the external application is a Web system, a native application or any software service that can be dynamically loaded to run, wherein when a startup module of the external application is dynamically loaded and executed, the external application is dynamically loaded to run.

5. The method according to claim 4, wherein the external application is dynamically loaded to run through an additional software module, wherein the additional software module is another independently running software system or a software component that can dynamically load and run a heterogeneous system, and wherein the software module and the additional software module are executed in a same operating system (OS) process or different OS processes.

6. The method according to claim 1, wherein the information exchange request is transmitted from an external network to a machine running the software system, and the information exchange request is transmitted to the software module, wherein the external network is an information transmission channel, wherein when the information exchange request is sent to the machine, a transmission identification code for receiving the information exchange request is not previously registered to the information transmission channel, the software system and/or the software module by the external application.

7. The method according to claim 6, wherein a process of identifying the information exchange request is implemented by identifying a data structure of the information exchange request, and/or identifying the information transmission channel, and/or identifying a service identification code corresponding to the information exchange activity or the external application.

8. The method according to claim 5, wherein the content of the information exchange request contains an information that is used to generate the response interface, wherein the response interface is generated by the external application, the software system or the software module during an operation of the connection flow, or the response interface is generated by the additional software module that is triggered during the operation of the connection flow, wherein a man-machine interface template of the response interface is applied when the response interface is generated, and the task of accessing the information exchange activity is executed after the user performs an operation on an operable window component in the response interface, wherein the operable window component provides a confirmation intention to guide the user to access the information exchange activity.

9. The method according to claim 1, wherein the content of the information exchange request contains a metadata of the information exchange activity, and the external application accesses the information exchange activity according to an information of the metadata.

10. The method according to claim 9, wherein the metadata is embedded in the link in the content of the information exchange request.

11. The method according to claim 5, wherein the software component that can dynamically load and run the heterogeneous system is a software component embedded in a software application, and the software component executes the heterogeneous system through a software engine that is independent of the software application, and/or the heterogeneous system is executed in an independent sandbox, wherein the heterogeneous system is a Web system, a native application or any software service that can be dynamically loaded to run.

12. The method according to claim 1, wherein the content of the information exchange request contains an access token for acquiring an authority of accessing the information exchange activity.

13. The method according to claim 1, wherein the activation of the connection flow, a procedure of generating the response interface and a procedure of dynamically loading and running the external application are performed in a same operating system (OS) process in a same machine, in different OS processes in the same machine and/or in different machines.

14. The method according to claim 6, wherein the information exchange activity is an online activity that is generated through an interaction between at least one person and a network communication service, wherein after accessing the online activity, the at least one person, or the at least one person and at least another person exchanges information in real time through a network.

15. The method according to claim 14, wherein the network communication service is an authorized network communication service with a permission, and the permission is authorized by the information transmission channel or the software system so as to transmit the information exchange request, wherein when the information exchange request is transmitted, the network communication service and a client software of the network communication service are not installed or imported into the software system and a machine running the software system.

16. The method according to claim 1, wherein the information exchange request is used for importing a work process corresponding to the information exchange activity, and the work process is dynamically imported into a machine running the software module according to an execution state of the information exchange activity.

17. A machine for dynamically connecting a network communication channel, the machine comprising a software module, wherein the software module receives an information exchange request, and the software module triggers activation of a connection flow in response to the information exchange request, wherein during the connection flow, a response interface corresponding to the information exchange request is generated for a user to operate according to a content of the information exchange request, and the user is guided to perform a task of accessing an information exchange activity through the response interface, wherein the task of accessing the information exchange activity is executed by an external application that is dynamically loaded to run, and the external application accesses the information exchange activity by connecting the network communication channel corresponding to the information exchange activity, wherein a content of the information exchange request contains a link that is used to point to a network address of the external application, and the external application is dynamically loaded to run through the network address during the connection flow.

18. A computer program product, wherein a content of the computer program product has a machine-executable instruction, wherein when the machine-executable instruction is executed, a machine executes the method according to at least one of the claims 1 to 16.
